(19) United States
(12) Patent Application Publication
(10) Pub. No.: US 2025/0338068 A1
(43) Pub. Date: Oct. 30, 2025

(54) HEARING AID WITH ADAPTIVE NOISE CANCELLER

(71) Applicant: Oticon A/S, Smørum (DK)

(72) Inventors: Poul HOANG, Smørum (DK); Jan M. DE HAAN, Smørum (DK); Michael Noes GÄTKE, Smørum (DK)

(21) Appl. No.: 19/089,036

(22) Filed: Mar. 25, 2025

(30) Foreign Application Priority Data
Apr. 24, 2024 (EP) 24172188.5

(51) Int. Cl. H04R 25/00; G10K 11/178

(52) U.S. Cl. CPC H04R 25/50; G10K 11/17817; H04R 2460/01

(57) ABSTRACT

Embodiments of a hearing aid are disclosed. A first detector can be configured to determine a first audio parameter. A first noise canceller can be configured to receive a first noise canceller input signal based on a beamformed signal and the first detector output signal and determine a first anti-noise signal based on the first noise canceller input signal. A second noise canceller can be configured to receive a second noise canceller input signal based on a second beamformed signal and determine a second anti-noise signal. An output interface can e configured to determine an output signal based on the first beamformed signal, the first anti-noise signal, and the second anti-noise signal, and output the output signal.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### TECHNICAL FIELD

The present application relates to the field of hearing aids.

### SUMMARY

In an aspect of the present application a hearing aid is provided. The hearing aid comprises an input interface configured to provide a plurality of input audio signals. The hearing aid comprises a first beamformer configured to receive a first beamformer input signal based on the plurality of input audio signals, and determine a first beamformed signal based on the first beamformer input signal. The hearing aid comprises a second beamformer configured to receive a second beamformer input signal based on the plurality of input audio signals, and determine a second beamformed signal based on the second beamformer input signal. The hearing aid comprises a first detector configured to receive a first detector input signal based on the plurality of input audio signals, determine a first audio parameter based on the first detector input signal, determine a first detector output signal based on the determined first audio parameter. The first detector outputs the first detector output signal. The hearing aid comprises a first noise canceller configured to receive a first noise canceller input signal based on the second beamformed signal and the first detector output signal, determine a first anti-noise signal based on the first noise canceller input signal, where the first anti-noise signal is an anti-noise signal for a first type of noise, and output the first anti-noise signal. The hearing aid comprises a second noise canceller configured to receive a second noise canceller input signal based on the second beamformed signal, determine a second anti-noise signal based on the second beamformed signal, where the second anti-noise signal is an anti-noise signal for a second type of noise, and output a second anti-noise signal. The hearing aid comprises an output interface. The output interface is configured to determine an output signal based on the first beamformed signal, the first anti-noise signal, and the second anti-noise signal, and output the output signal.

Consequently, an improved hearing aid is provided.

The input interface may comprise a plurality of input transducers. The input transducers may be a plurality of microphones for converting input sounds to a plurality of electric input signals. The input interface may convert electric input signals to input audio signals. The input interface may comprise a wireless interface for receiving the plurality of input audio signals through a wireless link. The wireless interface may comprise a wireless receiver.

The plurality of input audio signals may be indicative of sound. The plurality of input audio signals may be indicative of sound at a near-end, i.e. in an environment surrounding the hearing aid. The plurality of input audio signals may be indicative of sound at a far-end, i.e. received from another device communicatively connected to the hearing aid. The plurality of input audio signals may be a plurality of time-frequency domain signals. The plurality of input audio signal may be a plurality of time-domain signals.

The first beamformer may comprise a target distortion-less beamformer. The target distortion-less beamformer may comprise one or more of the following: a delay-and-sum beamformer, a delay-and-subtract beamformer, a minimum variance distortion-less response beamformer, a minimum power distortion-less response, and a linearly constrained minimum variance beamformer. The first beamformer may comprise a plurality of first beamformer weights. The first beamformer may be configured to be an adaptive beamformer such that the first beamformer weights may change over time. The first beamformer may be configured to be a fixed beamformer such that the first beamformer weights are fixed over time.

The first beamformer may be configured to determine the first beamformed signal by applying the plurality of first beamformer weights to the first beamformer input signal. The first beamformer may be configured to determine the first beamformed signal by beamforming the first beamformer input signal. The first beamformer may be configured to determine the first beamformed signal by applying one or more beamforming algorithms, e.g., delay-and-sum beamformer, MVDR beamformer, GSC beamformer, differential beamformer etc.

The first beamformer input signal may be the plurality of input audio signals. The first beamformer input signal may be a plurality of modified input audio signals. The plurality of input audio signals may be modified by down-sampling, up-sampling, or other prior processing.

The second beamformer may comprise a target cancelling beamformer. The target cancelling beamformer may comprise a delay-and-subtract beamformer configured to cancel a target signal (e.g. a desired speech signal). The second beamformer may comprise a plurality of second beamformer weights. The second beamformer may be configured to be adaptive beamformer such that the second beamformer weights may change over time. The first beamformer may be configured to be a fixed beamformer such that the first beamformer weights are fixed over time. The second beamformer may comprise a plurality of target cancelling beamformers, each configured to cancel the target signal.

In the present disclosure a target may be understood as a desired part of the signal. E.g., for a telecommunication the target may be an own-voice. For hearing aids a target may be speech intended for the user of the hearing aid.

The second beamformer input signal may be the plurality of input audio signals. Alternatively, the second beamformer input signal may be a plurality of modified input audio signals.

The second beamformer may be configured to determine the second beamformed signal by applying the plurality of second beamformer weights to the second beamformer input signal. The second beamformer may be configured to determine the second beamformed signal by beamforming the second beamformer input signal. The second beamformer may be configured to determine the second beamformed signal by applying one or more beamforming algorithms, e.g., delay-and-sum beamformer, MVDR beamformer, GSC beamformer, differential beamformer etc.

The first detector may be a voice activity detector configured to detect the presence of speech in the first detector input signal. The first detector may be an own voice detector configured to detect speech of a user of the hearing aid in the first detector input signal. The first detector may be a target voice detector configured to detect speech of a target speaker in the first detector input signal. The first detector may be a noise-only detector configured to detect the presence of noise-only (i.e. no speech) in the first detector input signal. The first detector may be a voice activity detector. The first detector may be an own-voice activity detector.

The first detector input signal may be the first beamformer input signal or second beamformer input signal. The first detector input signal may be the plurality of input audio signals. The first detector input signal may be based on a plurality of modified input audio signals. The input audio signal of a reference microphone of the hearing aid may be used as the first detector input signal. For example, the reference microphone of the hearing aid may be a frontal microphone of a behind-the-ear hearing aid. For example, the reference microphone of the hearing aid may be a rear microphone of a behind-the-ear hearing aid.

The first audio parameter may be a noise level or a signal-to-noise ratio of the first detector input signal. The first audio parameter may be a parameter indicative of speech in the first detector input signal, or the absence thereof. The first audio parameter may be a speech presence probability value. The first audio parameter may be a voice activity parameter configured to indicate the presence of speech in the first detector input signal. The first audio may be a noise-only parameter configured to indicate the presence of noise-only (i.e. no speech) in the detector input beamformer input signal. The first audio parameter may be a noise-only presence probability value.

The first audio parameter may comprise the energy of the first detector input signal. For example, the first audio parameter may be a power value of the first detector input signal. For example, the first audio parameter may be a plurality of power values of the first detector input signal. A power value may comprise a temporal smoothing of a magnitude value of the first detector input signal, wherein a magnitude value may include the absolute value, the absolute-square value, and the logarithmic value of any of the forementioned values. The temporal smoothing may comprise a first order recursive filter comprising a time constant. Alternatively, the temporal smoothing may comprise a first order recursive filter comprising an attack time constant and a release time constant.

The first audio parameter may comprise a plurality of power values of the first detector input signal. Each power value may be determined using a recursive filter comprising an attack time constant and a release time constant.

The first audio parameter may comprise a likelihood value based on a likelihood function. The likelihood function may be based on a probability model, e.g. a Gaussian distribution. The likelihood value may be determined based on the first detector input signal and the likelihood function. The first audio parameter may comprise a likelihood ratio or a log-likelihood ratio. The likelihood ratio may be based on a plurality of likelihood values. For example, the likelihood ratio may be based on a first likelihood value under the hypothesis that speech is absent, and a second likelihood value under the hypothesis that speech is absent.

The first audio parameter may comprise a binary value. The binary value may indicate the presence of speech in the first detector input signal. For example, a value of ‘1’, may indicate the presence of speech and a value of ‘0’ may indicate the absence of speech. The binary value may indicate the presence of noise-only. For example, a value of ‘1’, may indicate the presence of noise-only and a value of ‘0’ may indicate the absence of noise-only.

The first audio parameter may comprise a probability value. The probability value may indicate the likelihood of the presence of speech in the first detector input signal. For example, a probability value close to ‘1’ may indicate a higher likelihood of speech in the first detector input signal than a probability value closer to ‘0’. The binary value may indicate the presence of noise-only. For example, a probability value close to ‘1’ may indicate a higher likelihood of noise-only in the first detector input signal than a probability value closer to ‘0’.

The first detector output signal may comprise the first audio parameter. The first detector output signal may comprise a processed version of the first audio parameter.

The first noise canceller may comprise a complex-valued number used to modify the amplitude and the phase of the first noise canceller input signal. The amplitude and the phase of the first noise canceller input signal may be modified by a complex conjugate product between the first noise canceller input signal and the complex-valued number of the first noise canceller. The complex-valued number of the first noise canceller may be determined based on minimizing the square-error between the first beamformed signal and the first noise canceller output signal.

For minimizing the error the first noise canceller may comprise an iterative solver such as a gradient descent algorithm. A gradient descent algorithm may be a least mean square algorithm, a normalized least mean square algorithm, or a sign-sign least mean square algorithm. Alternatively, a closed form solution may be applied to minimize the error.

The first noise canceller input signal may be the second beamformer output signal. The first noise canceller input signal may be a modified second beamformer output signal, where the second beamformer output signal have been modified by filtering or amplification or other prior processing.

The first anti-noise signal may be the output of the first noise canceller and determined by a complex conjugate product between the first noise canceller input signal and the complex-valued number of the first noise canceller. The first anti-noise signal may be indicative of a first type of noise in the plurality of input audio signals. The first anti-noise signal may be a noise signal indicative of a first type of noise in the plurality of input audio signals.

In the present context an anti-noise signal may be understood as a signal which when combined with the original signal from which the anti-noise signal is derived is meant to remove noise from the original signal or a first beamformed signal. The anti-noise signal may be a noise signal, which is meant to be subtracted from the original signal or the first beamformed signal to thereby remove noise from the original signal or the first beamformed signal.

The first type of noise may include, but not limited to, ambient noise, reverberation, microphone self-noise, wind-noise, machine noise, colored noise (e.g. the sound produced by an electrical fan, a vacuum cleaner, car cabin noise). The first type of noise may be characterized by its power spectral density (or periodogram) being slowly time-varying than compared to the power spectral density (or periodogram) of speech.

The second noise canceller may comprise a complex-valued number used to modify the amplitude and the phase of the second noise canceller input signal. The amplitude and the phase of the second noise canceller input signal may be modified by a complex conjugate product between the second noise canceller input signal and the complex-valued number of the second noise canceller. The complex-valued number of the second noise canceller may be determined based on minimizing the square-error between the first beamformer output signal and the second noise canceller output signal.

The second noise canceller may comprise an iterative solver such as a gradient descent algorithm.

The second noise canceller input signal may be the second beamformer output signal. The second noise canceller input signal may be a modified second beamformer output signal, where the second beamformer output signal may be modified by filtering, amplification, or other processing.

The second anti-noise signal may be the output of the second noise canceller and determined by a complex conjugate product between the second noise canceller input signal and the complex-valued number of the second noise canceller. The second anti-noise signal may be indicative of a second type of noise in the plurality of input audio signals. The second anti-noise signal may be a noise signal indicative of a second type of noise in the plurality of input audio signals.

The second type of noise may include, but not limited to, (undesired) speech, transient noise, reverberation. The second type of noise may be characterized by its power spectral density (or periodogram) being equally or more time-varying compared to the power spectral density (or periodogram) of speech.

The output interface may be configured to provide a stimulus perceived by the user as an acoustic signal based on the output signal. The output interface unit may be a vibrator of a bone conducting hearing aid. The output interface unit may comprise an output interface transducer. The output interface transducer may comprise a receiver (loudspeaker) for providing the stimulus as an acoustic signal to the user (e.g. in an acoustic (air conduction based) hearing aid). The output interface transducer may comprise a vibrator for providing the stimulus as mechanical vibration of a skull bone to the user (e.g. in a bone-attached or bone-anchored hearing aid). The output interface unit may (additionally or alternatively) comprise a (e.g. wireless) transmitter for transmitting sound picked up-by the hearing aid to another device, e.g. a far-end communication partner (e.g. via a network, e.g. in a telephone mode of operation).

The output signal may be based on a linear combination of the first beamformed signal, the first anti-noise signal, and the second anti-noise signal. The output signal may be the first anti-noise signal and the second anti-noise signal subtracted from the first beamformed signal.

The first advantage of the present disclosure is an improved attenuation of a first type of noise and a second type of noise. The second advantage is improved audio quality of a target signal. The third advantage of the present disclosure is the use of a first noise canceller and a second noise canceller, where the first noise canceller determines a first anti-noise signal and the second noise canceller determine a second anti-noise signal. Thereby, the present disclosure provides a hearing aid with improved removal or attenuation of two types of noise compared to hearing aids using one noise canceller.

The benefits of using a multi-stage noise cancelling structure is higher flexibility and better control over the behavior of the noise reduction system. Each noise canceller may be provided with its own parameters. The detector is responsible for ensuring that the noise canceller only updates and adapts to unwanted noise sources as determined by the detector's detection of the presence of the unwanted noise.

In an embodiment the interface comprises two or more microphones configured to provide the plurality of input audio signals.

An advantage of using two or more microphones is improved attenuation of the first and second type of noise.

In an embodiment the first beamformer is a fixed filter, i.e. the first beamformer weights do not change over time. The second beamformer is a fixed filter, i.e. the second beamformer weights do not change over time. The first noise canceller is an adaptive filter. The second noise canceller is an adaptive filter.

One advantage of the use of fixed filters for the first and second beamformer is reduced computational complexity and robustness in difficult sound environments.

The first type of noise may be a slow time-varying noise. The second type of noise may be a fast time-varying noise.

A slow time-varying noise may be one or more of the following: ambient noise, reverberation, microphone self-noise, wind-noise, machine noise, and colored noise (e.g. the sound produced by an electrical fan, a vacuum cleaner, car cabin noise). A slow time-varying noise may be characterized by its power spectral density (or periodogram) being slowly time-varying than compared to the power spectral density (or periodogram) of speech.

A fast-time varying noise may be one or more of the following: undesired speech, transient noise, acoustic feedback, reverberation, and echo. The fast-time varying noise may be characterized by its power spectral density (or periodogram) being equally or more time-varying compared to the power spectral density (or periodogram) of speech.

Hence, one advantage is the present disclosure proposes a hearing aid with improved removal or attenuation of a slow time-varying noise and a fast time-varying noise.

In an embodiment the first noise canceller comprises a first smoothing factor. The second noise canceller comprises a second smoothing factor. The smoothing factors defines the adaptation rate of the associated noise canceller. The first smoothing factor results in a lower adaptation rate than the second smoothing factor.

The first smoothing factor may be used to determine the adaptation rate of the first noise canceller. A low first smoothing factor may be used to configure the first noise canceller to adapt to slow time-varying noise compared to a large first smoothing factor. The first smoothing factor may be used for an iterative solver such a gradient descent algorithm.

The second smoothing factor may be used to determine the adaptation rate of the second noise canceller. A high second smoothing factor may be used to configure the second noise canceller to adapt to fast time-varying noise compared to a slow first smoothing factor. The second smoothing factor may be used for an iterative solver such a gradient descent algorithm.

In the present context a smoothing factor may be understood as a factor determining the weight given to the most recent estimation as compared to the prior estimation.

Hence, one advantage of the present disclosure is a hearing aid comprising a first smoothing factor for improved attenuation of slow time-varying noise and a second smoothing for factor for improved attenuation of fast time-varying noise.

In an embodiment determining the first detector output signal comprises comparing the first audio parameter to a first threshold. If the first audio parameter exceeds the first threshold, determining the first detector output signal as comprising an activation signal. The activation signal allowing the first noise canceller to adapt by reducing an error between the first anti-noise signal and a first target signal based on the first beamformed signal. If the first audio parameter does not exceed the first threshold, determining the first detector output signal as comprising a fixing signal. The fixing signal fixing the first noise canceller.

The first threshold may be a pre-defined value. The first threshold may be a pre-defined value between a value of ‘0’ and ‘1’. For example, the first threshold may be 0.5. For example, the first threshold may be selected in the range 0.1 to 0.9.

The first threshold may be an adaptive value. For example, the first threshold may be determined based on a noise level or a signal-to-noise ratio. The noise level or signal-to-noise ratio may be determined by the first detector, e.g., as the first audio parameter. A high noise level may bias the first threshold to be closer to a value of ‘1’ compared to a lower noise level which may bias the first threshold to be closer to a value of ‘0’. A low signal-to-noise ratio may bias the first threshold to be closer to a value of ‘1’ compared to a higher noise level which may bias the first threshold to be closer to a value of ‘0’.

In the present disclosure allowing a noise canceller to adapt may be understood as changing one or more parameters/coefficients comprised by the noise canceller.

In the present disclosure fixing a noise canceller may be understood as keeping one or more parameters/coefficients comprised by the noise canceller fixed, i.e., not changing the parameters/coefficients.

The activation signal may be a binary value, wherein a value of ‘1’ allows adaptation of the first noise canceller. The activation signal may be based on the first detector output signal. The activation signal may be a value between ‘0’ and ‘1’ value, not including ‘0’.

The first target signal may be the first beamformed signal. The first target signal may be a processed version of the first beamformed signal. The first target signal may comprise a speech signal from a speaker plus noise. The first target signal may be a linear combination of the first beamformed signal and the first anti-noise signal. The first target signal may be a signal based on a sound from a multi-media device such as a television, phone, sound system. The first target signal may be a sound from live entertainment.

The error between the first target signal and the first anti-noise signal may be computed as the difference. The error may be computed as the absolute value (or absolute-square value) of the difference. The error may be computed as the logarithm of the absolute value (or absolute-square value) of the difference.

Reducing the error between the first target signal and the first anti-noise signal may be achieved by reducing the average or mean difference between the first target signal and the first anti-noise signal. Reducing the error between the first target signal and the first anti-noise signal may be achieved by reducing the average or mean absolute value or absolute-square value of the difference between the first target signal and the first anti-noise signal. Reducing the error between the first target signal and the first anti-noise signal may comprise using an iterative solver minimizing the mean-square error between the first target signal and the first anti-noise signal, e.g. a gradient algorithm. Reducing the error between the first target signal and the first anti-noise signal may comprise using a closed-form equation based on minimizing the mean-square error between the first target signal and the first anti-noise signal.

The fixing signal may be a binary value, wherein a value of ‘0’ halts the adaptation of, i.e. fixes, the first noise canceller. The fixing signal may be based on the first detector output signal.

Thereby, the disclosed hearing aid comprising the first noise canceller has the advantage of being controlled by the first detector output signal. Specifically, the advantage is adaptation to a first type of noise for improved noise reduction and improved speech enhancement of a desired speech signal.

In an embodiment the hearing aid may comprise a second detector. The second detector being configured to receive a second detector input signal based on the plurality of input audio signals. The second detector determines a second audio parameter based on the second detector input signal. The second detector determines a second detector output signal based on the determined second audio parameter. The second detector outputs the second detector output signal. The second noise canceller is configured to receive the second detector output signal.

The second noise canceller is configured to determine the second anti-noise signal based on the second detector output signal.

The second detector may be an interference detector configured to detect the presence of interference in the second detector input signal. The interference detector may be based on determining modulation changes in the first beamformer input signal. For example, modulation changes may be based on determining changes in the energy level in the second detector input signal. The interference detector may be based on determining a spatial characteristic in the second detector input signal. For example, the spatial characteristic in the second detector input signal may be used to determine the direction or location of the sound sources in the second detector input signal. The spatial characteristic may be based on determining the correlation(s) between the plurality of input audio signals. The second detector may comprise a trained neural network configured to detect interference in the second detector input signal.

In the present disclosure interference may be understood as highly modulated noise. Interference may be understood as noise having a transient nature. Interference may for example be speech from a non-desired source.

The second detector input signal may be the first or second beamformer input signal. The second detector input signal may be the plurality of input audio signals or the plurality of modified input audio signals. The input audio signal of a reference microphone of the hearing aid may be used as the second detector input signal.

The second audio parameter may be an interference parameter indicative of interference in the second detector input signal. The second audio parameter may be a noise level or a signal-to-noise ratio of the second detector input signal. The second audio parameter may be a parameter indicative of interference in the second detector input signal, or the absence thereof.

The second audio parameter may comprise the energy of the second detector input signal. For example, the second audio parameter may be a power value of the second detector input signal. For example, the second audio parameter may be a plurality of power values of the second detector input signal. A power value may comprise a temporal smoothing of a magnitude value of the second detector input signal, wherein a magnitude value may include the absolute value, the absolute-square value, and the logarithmic value of any of the forementioned values. The temporal smoothing may comprise a first order recursive filter comprising a time constant. Alternatively, the temporal smoothing may comprise a first order recursive filter comprising an attack time constant and a release time constant.

The second audio parameter may comprise a plurality of power values of the second detector input signal. Each power value may be determined using a recursive filter comprising an attack time constant and a release time constant.

The second audio parameter may comprise a correlation based value. For example, a correlation based value may comprise the cross-correlation between the input audio signals.

The second audio parameter may comprise a likelihood value based on a likelihood function. The likelihood function may be based on a probability model, e.g. a Gaussian distribution. The likelihood value may be determined based on the second detector input signal and the likelihood function. The second audio parameter may comprise a likelihood ratio or a log-likelihood ratio. The likelihood ratio may be based on a plurality of likelihood values. For example, the likelihood ratio may be based on a first likelihood value under the hypothesis that the interference is absent, and a second likelihood value under the hypothesis that the interference is absent. Alternative, the likelihood ratio may be based on a first likelihood value under the hypothesis that the interference is present a first spatial location, and a second likelihood value under the hypothesis that the interference is not present from the first spatial location.

The second audio parameter may comprise a binary value. The binary value may indicate the presence of interference in the second detector input signal. For example, a value of ‘1’, may indicate the presence of interference and a value of ‘0’ may indicate the absence of interference.

The second audio parameter may comprise a probability value. The probability value may indicate the likelihood of the presence of interference in the second detector input signal. For example, a probability value close to ‘1’ may indicate a higher likelihood of interference in the second detector input signal than a probability value closer to ‘0’.

The second detector output signal may comprise the second audio parameter. The first detector output signal may comprise a processed version of the second audio parameter.

Thereby, the disclosed hearing aid comprising the second noise canceller has the advantage of being controlled by the second detector output signal. Specifically, the advantage is adaptation to a second type of noise for improved noise reduction and improved speech enhancement of a desired speech signal.

In an embodiment determining the second detector output signal comprises comparing the second audio parameter to a second threshold. If the second audio parameter exceeds the second threshold, determining the second detector output signal as comprising an activation signal. The activation signal allows the second noise canceller to adapt by reducing an error between a second target signal based on the second beamformed signal and the second anti-noise signal. If the second audio parameter does not exceed the second threshold, determining the second detector output signal as comprising a fixing signal. The fixing signal fixing the second noise canceller.

The second threshold may be a pre-defined value. The second threshold may be a pre-defined value between a value of ‘0’ and ‘1’. For example, the second threshold may be 0.5. For example, the second threshold may be selected in the range 0.1 to 0.9.

The second threshold may be an adaptive value. For example, the second threshold may be determined based on a noise level or a signal-to-noise ratio. The noise level or signal-to-noise ratio may be determined by the second detector, e.g., as the second audio parameter. A high noise level may bias the second threshold to be closer to a value of ‘1’ compared to a lower noise level which may bias the second threshold to be closer to a value of ‘0’. A low signal-to-noise ratio may bias the second threshold to be closer to a value of ‘1’ compared to a higher noise level which may bias the second threshold to be closer to a value of ‘0’.

The activation signal may be a binary value, wherein a value of ‘1’ allows adaptation of the second noise canceller. The activation signal may be based on the second detector output signal. Alternatively, the activation signal may be a value between ‘0’ and ‘1’ value, not including ‘0’.

The error between the second target signal and the second anti-noise signal may be computed as the difference. The error may be computed as the absolute value (or absolute-square value) of the difference. The error may be computed as the logarithm of the absolute value (or absolute-square value) of the difference.

Reducing the error may be reducing the average (or mean) difference between the second target signal and the second anti-noise signal. Reducing the error may be reducing the average (or mean) absolute value (or absolute-square value) of the difference between the second target signal and the second anti-noise signal. Reducing the error may comprise using an iterative solver such as a gradient algorithm. Reducing the error may comprise using a closed-form equation based on minimizing the mean-square error between the second target signal and the second anti-noise signal.

The second target signal may be the second beamformed signal. The second target signal may comprise a speech signal from a speaker plus noise. The second target signal may be a linear combination of the second beamformed signal and the second anti-noise signal. The second target signal may be a signal based on a sound from a multi-media device such as a television, phone, sound system. The first target signal may be a sound from live entertainment.

The fixing signal may be a binary value, wherein a value of ‘0’ halts the adaptation of, i.e. fixes, the second noise canceller. The fixing signal may be based on the second detector output signal.

In an embodiment the second audio parameter is an interference activity parameter.

The interference activity parameter may comprise a correlation based value. For example, a correlation based value may comprise the cross-correlation between the input audio signals.

The interference activity parameter may comprise a likelihood value based on a likelihood function. The likelihood function may be based on a probability model, e.g. a Gaussian distribution. The likelihood value may be determined based on the second detector input signal and the likelihood function. The interference activity parameter may comprise a likelihood ratio or a log-likelihood ratio. The likelihood ratio may be based on a plurality of likelihood values. For example, the likelihood ratio may be based on a first likelihood value under the hypothesis that the interference is absent, and a second likelihood value under the hypothesis that the interference is absent. Alternative, the likelihood ratio may be based on a first likelihood value under the hypothesis that the interference is from a first spatial location, and a second likelihood value under the hypothesis that the interference is from a second spatial location.

Interference may be understood as undesired speech, e.g. coming from people in close vicinity to the user of the hearing aid.

In an embodiment the first audio parameter is a voice activity parameter.

The voice activity parameter may comprise the energy of the first detector input signal. For example, the voice activity parameter may be a power value of the first detector input signal. For example, the voice activity parameter may be a plurality of power values of the first detector input signal. A power value may comprise a temporal smoothing of a magnitude value of the first detector input signal, wherein a magnitude value may include the absolute value, the absolute-square value, and the logarithmic value of any of the forementioned values. The temporal smoothing may comprise a first order recursive filter comprising a time constant. The temporal smoothing may comprise a first order recursive filter comprising an attack time constant and a release time constant.

The voice activity parameter may comprise a plurality of power values of the first detector input signal. Each power value may be determined using a recursive filter comprising an attack time constant and a release time constant.

The voice activity parameter may comprise a likelihood value based on a likelihood function. The likelihood function may be based on a probability model, e.g. a Gaussian distribution. The likelihood value may be determined based on the first detector input signal and the likelihood function. The voice activity parameter may comprise a likelihood ratio or a log-likelihood ratio. The likelihood ratio may be based on a plurality of likelihood values. For example, the likelihood ratio may be based on a first likelihood value under the hypothesis that speech is absent, and a second likelihood value under the hypothesis that speech is absent.

In an embodiment the hearing aid comprises a first gain controller. The first gain controller is configured to receive the first anti-noise signal. The first gain controller determines a first control gain. The first gain controller applies the first control gain to the first anti-noise signal. The first gain controller outputs a first noise-controlled signal. The output interface is configured to determine the output signal based on the first noise-controlled signal.

A control gain may be used to control the aggressiveness of the associated noise canceller.

The first control gain may comprise a real-value between ‘0’ and ‘1’. The first noise-controlled signal may be a modified first anti-noise signal. The modified first anti-noise signal may be the applied first control gain to the first anti-noise signal. The first control gain may be a global gain configured to be applied over the full spectrum of a signal. The first control gain may be frequency specific gain configured to be applied to parts of the spectrum of a signal.

In an embodiment the first control gain is a predetermined gain.

The first control gain may be a value between ‘0’ and ‘1’. The first control gain may be set as a factory setting. The first control gain may be set by an audiologist during a calibration procedure, or a fitting procedure of the hearing aid.

In an embodiment the first gain controller is configured to receive the first detector output signal: The first gain controller is configured to determine the first control gain based on the first detector output signal.

The first control gain may be determined as the first audio parameter, i.e. if the first audio parameter may be a value between 0 and 1, the first control gain may be determined to be a corresponding value as the first audio parameter. The first control gain may be determined as a function of the first audio parameter. The function may be determined by empirical testing.

In an embodiment the hearing aid comprises a second gain controller. The second gain controller is configured to receive the second anti-noise signal, determine a second control gain, apply the second control gain to the second anti-noise signal. The second gain controller outputs a second noise-controlled signal. The output interface is configured to determine the output signal based on the second noise-controlled signal.

The second control gain may comprise a real-value between ‘0’ and ‘1’. The second noise-controlled signal may be a modified second anti-noise signal. The modified second anti-noise signal may be the applied second control gain to the second anti-noise signal. The second control gain may be a global gain configured to be applied over the full spectrum of a signal. The second control gain may be frequency specific gain configured to be applied to parts of the spectrum of a signal.

In an embodiment the second control gain is a predetermined gain.

The second control gain may be a value between ‘0’ and ‘1’. The second control gain may be set as a factory setting. The second control gain may be set by an audiologist during a calibration procedure, or a fitting procedure of the hearing aid.

In an embodiment the second gain controller is configured to receive the second detector output signal: The second gain controller is configured to determine the second control gain based on the second detector output signal.

The second control gain may be determined as the second audio parameter, i.e. if the second audio parameter may be a value between 0 and 1, the second control gain may be determined to be a corresponding value as the second audio parameter. The second control gain may be determined as a function of the second audio parameter. The function may be determined by empirical testing.

In an embodiment the hearing aid comprises a third detector. The third detector is configured to receive a third detector input signal based on the plurality of input audio signals. The third detector determines a third audio parameter based on the third detector input signal. The third detector determines a third detector output signal based on the determined third audio parameter. The third detector outputs the third detector output signal. The hearing aid comprises a third noise canceller. The third noise canceller is configured to receive a third noise canceller input signal based on the second beamformed signal and the third detector output signal. The third noise canceller determines a third anti-noise signal based on the third noise canceller input signal, where the third anti-noise signal is an anti-noise signal for a third type of noise. The third noise canceller outputs a third anti-noise signal. The output interface is configured to determine the output signal based on the third anti-noise signal.

The third detector may be a feedback detector (or an echo detector) configured to detect the presence of feedback or echo in the third detector input signal. The feedback detector may be based on determining the presence of howling in the third detector input signal. For example, the presence of howling may be based on spectral analysis, e.g., by determining the power ratio of between neighboring frequency sub-bands. The feedback detector may be based on determining the presence of sound from a specific location where feedback is likely to originate. For example, the acoustic path between the hearing aid microphones and the receiver may be used to determine the specific location of the feedback.

The third detector input signal may be the first or second beamformer input signal. The third detector input signal may be the plurality of input audio signals. The input audio signal of a reference microphone of the hearing aid may be used as the third detector input signal. For example, the reference microphone of the hearing aid may be the frontal microphone of a behind-the-ear hearing aid.

The third audio parameter may be a feedback parameter (or an echo parameter) configured to indicate the presence of feedback or echo in the third detector input signal.

The third audio parameter may comprise the spectral energy of the third detector input signal. The third audio parameter may be a spectral ratio of spectral energies between neighboring sub-bands. For example, the third audio parameter may be a power value of the third detector input signal. For example, the third audio parameter may be a plurality of power values or spectral ratios of the third detector input signal. A power value may comprise a temporal smoothing of a magnitude value of the third detector input signal, wherein a magnitude value may include the absolute value, the absolute-square value, and the logarithmic value of any of the forementioned values. The temporal smoothing may comprise a first order recursive filter comprising a time constant. Alternatively, the temporal smoothing may comprise a first order recursive filter comprising an attack time constant and a release time constant.

The third audio parameter may comprise a plurality of power values of the third detector input signal. Each power value may be determined using a recursive filter comprising an attack time constant and a release time constant.

The third audio parameter may comprise a correlation based value. For example, a correlation based value may comprise the cross-correlation between the plurality of input audio signals.

The third audio parameter may comprise a likelihood value based on a likelihood function.

The likelihood function may be based on a probability model, e.g. a Gaussian distribution. The likelihood value may be determined based on the third detector input signal and the likelihood function. The third audio parameter may comprise a likelihood ratio or a log-likelihood ratio. The likelihood ratio may be based on a plurality of likelihood values. For example, the likelihood ratio may be based on a first likelihood value under the hypothesis that the feedback is absent, and a second likelihood value under the hypothesis that the feedback is absent.

Alternative, the likelihood ratio may be based on a first likelihood value under the hypothesis that the feedback is present from a first spatial location, and a second likelihood value under the hypothesis that the feedback is absent from the first spatial location.

The third detector output signal may comprise a binary value. The binary value may indicate the presence of feedback in the third detector input signal. For example, a value of ‘1’, may indicate the presence of feedback and a value of ‘0’ may indicate the absence of feedback.

The third detector output signal may comprise a probability value. The probability value may indicate the likelihood of the presence of feedback in the third detector input signal. For example, a probability value close to ‘1’ may indicate a higher likelihood of feedback in the third detector input signal than a probability value closer to ‘0’.

The third noise canceller may comprise a complex-valued number used to modify the amplitude and the phase of the third noise canceller input signal. The amplitude and the phase of the third noise canceller input signal may be modified by a complex conjugate product between the third noise canceller input signal and the complex-valued number of the third noise canceller. The complex-valued number of the third noise canceller may be determined based on minimizing the square-error between the first beamformer output signal and the third noise canceller input signal.

The third noise canceller may comprise an iterative solver such as a gradient descent algorithm.

The third noise canceller input signal may be the second beamformer output signal. Alternatively, the third noise canceller input signal is a modified third beamformer output signal, wherein the third beamformer output signal may be modified by filtering or amplification.

The third anti-noise signal may be the output of the third noise canceller and determined by a complex conjugate product between the third noise canceller input signal and the complex-valued number of the third noise canceller.

The third type of noise may include acoustic feedback. The third type of noise may be characterized by its howling. The howling may be detected based on a spectral howling detection algorithm.

In an embodiment the third audio parameter is an audio feedback parameter.

The audio feedback parameter may comprise the energy of the third detector input signal. For example, the audio feedback parameter may be a power value of the third detector input signal. For example, the audio feedback parameter may be a plurality of power values of the third detector input signal. A power value may comprise a temporal smoothing of a magnitude value of the third detector input signal, wherein a magnitude value may include the absolute value, the absolute-square value, and the logarithmic value of any of the forementioned values. The temporal smoothing may comprise a first order recursive filter comprising a time constant. Alternatively, the temporal smoothing may comprise a first order recursive filter comprising an attack time constant and a release time constant.

The audio feedback parameter may comprise a plurality of power values of the third detector input signal. Each power value may be determined using a recursive filter comprising an attack time constant and a release time constant.

The audio feedback parameter may comprise a likelihood value based on a likelihood function. The likelihood function may be based on a probability model, e.g. a Gaussian distribution. The likelihood value may be determined based on the third detector input signal and the likelihood function. The audio feedback parameter may comprise a likelihood ratio or a log-likelihood ratio. The likelihood ratio may be based on a plurality of likelihood values. For example, the likelihood ratio may be based on a first likelihood value under the hypothesis that feedback is absent, and a second likelihood value under the hypothesis that feedback is absent.

In an embodiment the hearing aid comprises a third gain controller configured to receive the third anti-noise signal, determine a third control gain, apply the third control gain to the third anti-noise signal, and output a third noise-controlled signal. The output interface is configured to determine the output signal based on the third noise-controlled signal.

The third control gain may comprise a real-valued between ‘0’ and ‘1’. The third noise-controlled signal may be a modified third anti-noise signal. The modified third anti-noise signal may be the applied third control gain to the third anti-noise signal. The third control gain may be a global gain configured to be applied over the full spectrum of a signal. The third control gain may be frequency specific gain configured to be applied to parts of the spectrum of a signal.

In an embodiment the third gain controller is configured to receive the third detector output signal: The third gain controller is configured to determine the third control gain based on the third detector output signal.

The adaptive gain may be determined based on the third detector output signal. The third detector output signal may be a value between ‘0’ and ‘1’. The third detector output signal may be a binary value. The third detector output signal may be a probability value indicating the presence or absence of the third type of noise.

In an embodiment the third control gain is a predetermined gain. The predetermined gain may be a value between ‘0’ and ‘l’.

In an embodiment the first beamformer is a beamformer with a distortion-less criteria.

The distortion-less criteria may be a linear constraint. The distortion-less criteria may be based on a target sound source. The linear constraint may be linear combination of the relative transfer function (i.e. the steering vector) of a target sound source using the beamformer weights of the first beamformer such that the output of the linear combination is equal to a predetermined value (e.g. a value of ‘1’). The target sound source may be a desired speaker located in the front of a hearing aid user. The hearing aid user wears the hearing aid, e.g. a behind-the-ear hearing aid. The target sound source may be the hearing aid user's own voice.

The beamformer with a distortion-less criteria may be any beamformer that satisfy the distortion-less criteria.

In an embodiment the second beamformer is a target cancelling beamformer.

The second beamformer may determine the second beamformed signal based on minimizing power of the target sound signal based on the plurality of input audio signals.

In an embodiment the hearing aid may comprises an air-conduction type hearing aid.

In an embodiment the hearing aid may comprises a bone-conduction type hearing aid.

In an embodiment determining the first anti-noise signal may comprise determining the correlation between the first beamformed signal and the first noise canceller input signal.

In an embodiment determining the first noise canceller comprises normalizing the correlation using the magnitude of the first noise canceller input signal. The magnitude may comprise the amplitude value, the absolute-square value or the logarithm of the forementioned.

In an embodiment determining the first noise canceller comprises determining the correlation between the first anti-noise signal and the first noise canceller input signal.

In an embodiment determining the first noise canceller comprises reducing the magnitude error between the first beamformed signal and the first noise canceller input signal.

In an embodiment determining the second noise canceller comprises determining the correlation between the first anti-noise signal and the first noise canceller input signal.

In an embodiment determining the first noise canceller comprises normalizing the correlation using the magnitude of the first noise canceller input signal.

In an embodiment determining the second noise canceller comprises determining the correlation between the second anti-noise signal and the first noise canceller input signal.

In an embodiment determining the first noise canceller comprises reducing the magnitude error between the second anti-noise signal and the first noise canceller input signal.

In an embodiment determining the second anti-noise signal comprises subtracting the second anti-noise signal from the first anti-noise signal.

In an embodiment determining the third noise canceller comprises determining the correlation between the second anti-noise signal and the first noise canceller input signal.

In an embodiment determining the third noise canceller comprises normalizing the correlation using the magnitude of the first noise canceller input signal.

In an embodiment determining the third noise canceller comprises determining the correlation between the third anti-noise signal and the first noise canceller input signal.

In an embodiment determining the third noise canceller comprises reducing the magnitude error between the third anti-noise signal and the first noise canceller input signal.

In an embodiment determining the third anti-noise signal comprises subtracting the third anti-noise signal from the second anti-noise signal.

According to a second aspect of the present disclosure a method of operating a hearing aid is provided, the method comprises providing a plurality of input audio signals. The method comprises determining a first beamformed signal based on the plurality of input audio signals. The method comprises determining a second beamformed signal based on the plurality of input audio signals. The method comprises determining a first audio parameter based on the plurality of input audio signal. The method comprises determining a first detector output signal based on the determined first audio parameter. The method comprises determining a first anti-noise signal related to a first type of noise based on the second beamformed signal and the first detector signal. The method comprises determining a second anti-noise signal related to a second type of noise based on the second beamformed signal. The method comprises determining an output signal based on the first beamformed signal, the first anti-noise signal, and the second anti-noise signal. The method comprises outputting the output signal.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a signal processor for enhancing the input signals and providing a processed output signal.

The wireless receiver and/or transmitter may e.g. be configured to receive and/or transmit an electromagnetic signal in the radio frequency range (3 kHz to 300 GHz). The wireless receiver and/or transmitter may e.g. be configured to receive and/or transmit an electromagnetic signal in a frequency range of light (e.g. infrared light 300 GHz to 430 THz, or visible light, e.g. 430 THz to 770 THz).

The hearing aid may comprise a directional microphone system adapted to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. This can be achieved in various different ways as e.g. described in the prior art. In hearing aids, a microphone array beamformer is often used for spatially attenuating background noise sources. The beamformer may comprise a linear constraint minimum variance (LCMV) beamformer. Many beamformer variants can be found in literature. The minimum variance distortion-less response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

Most sound signal sources (except the user's own voice) are located far way from the user compared to dimensions of the hearing aid, e.g. a distance d_{mic} between two microphones of a directional system. A typical microphone distance in a hearing aid is of the order 10 mm. A minimum distance of a sound source of interest to the user (e.g. sound from the user's mouth or sound from an audio delivery device) is of the order of 0.1 m (>10 d_{mic}). For such minimum distances, the hearing aid (microphones) would be in the acoustic near-field of the sound source and a difference in level of the sound signals impinging on respective microphones may be significant. A typical distance for a communication partner is more than 1 m (>100 d_{mic}). The hearing aid (microphones) would be in the acoustic far-field of the sound source and a difference in level of the sound signals impinging on respective microphones is insignificant. The difference in time of arrival of sound impinging in the direction of the microphone axis (e.g. the front or back of a normal hearing aid) is ΔT=d_{mic}/v_{sound}=0.01/343 [s]=29 μs, where v_{sound} is the speed of sound in air at 20° C. (343 m/s).

The hearing aid may comprise antenna and transceiver circuitry allowing a wireless link to an entertainment device (e.g. a TV-set), a communication device (e.g. a telephone), a wireless microphone, a separate (external) processing device, or another hearing aid, etc. The hearing aid may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

In general, a wireless link established by antenna and transceiver circuitry of the hearing aid can be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra WideBand (UWB) technology.

The hearing aid may be constituted by or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g, such as less than 20 g, such as less than 5 g.

The hearing aid may comprise a ‘forward’ or ‘signal’ path for processing an audio signal between an input and an output interface of the hearing aid. A signal processor may be located in the forward path. The signal processor may be adapted to provide a frequency-dependent gain according to a user's particular needs e.g. hearing impairment. The hearing aid may comprise an ‘analysis’ path comprising functional components for analyzing signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

An analogue electric signal representing an acoustic signal may be converted to a digital audio signal in an analogue-to-digital (AD) conversion process, where the analogue signal is sampled with a predefined sampling frequency or rate fₛ, fₛ being e.g. in the range from 8 kHz to 48 kHz (adapted to the particular needs of the application) to provide digital samples xₙ (or x[n]) at discrete points in time tₙ (or n), each audio sample representing the value of the acoustic signal at tₙ by a predefined number N_{b} of bits, N_{b} being e.g. in the range from 1 to 48 bits, e.g. 24 bits. Each audio sample is hence quantized using N_{b} bits (resulting in 2^{Nb} different possible values of the audio sample). A digital sample x has a length in time of 1/fₛ, e.g. 50 μs, for fₛ=20 kHz. A number of audio samples may be arranged in a time frame. A time frame may comprise 64 or 128 audio data samples. Other frame lengths may be used depending on the practical application.

The hearing aid may comprise an analogue-to-digital (AD) converter to digitize an analogue input (e.g. from an input transducer, such as a microphone) with a predefined sampling rate, e.g. 20 kHz. The hearing aids may comprise a digital-to-analogue (DA) converter to convert a digital signal to an analogue output signal, e.g. for being presented to a user via an output interface transducer.

The hearing aid, e.g. the input interface, and or the antenna and transceiver circuitry may comprise a transform unit for converting a time domain signal to a signal in the transform domain (e.g. frequency domain or Laplace domain, Z transform, wavelet transform, etc.). The transform unit may be constituted by or comprise a TF-conversion unit for providing a time-frequency representation of an input signal. The time-frequency representation may comprise an array or map of corresponding complex or real values of the signal in question in a particular time and frequency range. The TF conversion unit may comprise a filter bank for filtering a (time varying) input signal and providing a number of (time varying) output signals each comprising a distinct frequency range of the input signal. The TF conversion unit may comprise a Fourier transformation unit (e.g. a Discrete Fourier Transform (DFT) algorithm, or a Short Time Fourier Transform (STFT) algorithm, or similar) for converting a time variant input signal to a (time variant) signal in the (time-)frequency domain. The frequency range considered by the hearing aid from a minimum frequency fₘᵢₙ to a maximum frequency fₘₐₓ may comprise a part of the typical human audible frequency range from 20 Hz to 20 kHz, e.g. a part of the range from 20 Hz to 12 kHz. Typically, a sample rate fₛ is larger than or equal to twice the maximum frequency fₘₐₓ, fₛ≥2fₘₐₓ. A signal of the forward and/or analysis path of the hearing aid may be split into a number NI of frequency bands (e.g. of uniform width), where NI is e.g. larger than 5, such as larger than 10, such as larger than 50, such as larger than 100, such as larger than 500, at least some of which are processed individually. The hearing aid may be adapted to process a signal of the forward and/or analysis path in a number NP of different frequency channels (NP≤NI). The frequency channels may be uniform or non-uniform in width (e.g. increasing in width with frequency), overlapping or non-overlapping.

The hearing aid may be configured to operate in different modes, e.g. a normal mode and one or more specific modes, e.g. selectable by a user, or automatically selectable. A mode of operation may be optimized to a specific acoustic situation or environment, e.g. a communication mode, such as a telephone mode. A mode of operation may include a low-power mode, where functionality of the hearing aid is reduced (e.g. to save power), e.g. to disable wireless communication, and/or to disable specific features of the hearing aid.

The hearing aid may comprise a number of detectors configured to provide status signals relating to a current physical environment of the hearing aid (e.g. the current acoustic environment), and/or to a current state of the user wearing the hearing aid, and/or to a current state or mode of operation of the hearing aid. One or more detectors may form part of an external device in communication (e.g. wirelessly) with the hearing aid. An external device may e.g. comprise another hearing aid, a remote control, and audio delivery device, a telephone (e.g. a smartphone), an external sensor, etc.

One or more of the number of detectors may operate on the full band signal (time domain). One or more of the number of detectors may operate on band split signals ((time-)frequency domain), e.g. in a limited number of frequency bands.

The number of detectors may comprise a level detector for estimating a current level of a signal of the forward path. The detector may be configured to decide whether the current level of a signal of the forward path is above or below a given (L-)threshold value. The level detector may operate on the full band signal (time domain). The level detector may operate on band split signals ((time-)frequency domain).

The hearing aid may comprise a voice activity detector (VAD) for estimating whether or not (or with what probability) an input signal comprises a voice signal (at a given point in time). A voice signal may in the present context be taken to include a speech signal from a human being. It may also include other forms of utterances generated by the human speech system (e.g. singing). The voice activity detector unit may be adapted to classify a current acoustic environment of the user as a VOICE or NO-VOICE environment. This has the advantage that time segments of the electric microphone signal comprising human utterances (e.g. speech) in the user's environment can be identified, and thus separated from time segments only (or mainly) comprising other sound sources (e.g. artificially generated noise). The voice activity detector may be adapted to detect as a VOICE also the user's own voice.

The hearing aid may comprise an own voice detector for estimating whether or not (or with what probability) a given input sound (e.g. a voice, e.g. speech) originates from the voice of the user of the system. A microphone system of the hearing aid may be adapted to be able to differentiate between a user's own voice and another person's voice and possibly from NON-voice sounds.

The number of detectors may comprise a movement detector, e.g. an acceleration sensor. The movement detector may be configured to detect movement of the user's facial muscles and/or bones, e.g. due to speech or chewing (e.g. jaw movement) and to provide a detector signal indicative thereof.

The hearing aid may comprise a classification unit configured to classify the current situation based on input signals from (at least some of) the detectors, and possibly other inputs as well. In the present context ‘a current situation’ may be taken to be defined by one or more of
a) the physical environment (e.g. including the current electromagnetic environment, e.g. the occurrence of electromagnetic signals (e.g. comprising audio and/or control signals) intended or not intended for reception by the hearing aid, or other properties of the current environment than acoustic);
b) the current acoustic situation (input level, feedback, etc.), and
c) the current mode or state of the user (movement, temperature, cognitive load, etc.);
d) the current mode or state of the hearing aid (program selected, time elapsed since last user interaction, etc.) and/or of another device in communication with the hearing aid.

The classification unit may be based on or comprise a neural network, e.g. a recurrent neural network, e.g. a trained neural network.

The hearing aid may comprise an acoustic (and/or mechanical) feedback control (e.g. suppression) or echo-cancelling system. Adaptive feedback cancellation has the ability to track feedback path changes over time. It is typically based on a linear time invariant filter to estimate the feedback path but its filter weights are updated over time. The filter update may be calculated using stochastic gradient algorithms, including some form of the Least Mean Square (LMS) or the Normalized LMS (NLMS) algorithms. They both have the property to minimize the error signal in the mean square sense with the NLMS additionally normalizing the filter update with respect to the squared Euclidean norm of some reference signal.

The hearing aid may further comprise other relevant functionality for the application in question, e.g. compression, noise reduction, etc.

The hearing aid may comprise a hearing instrument, e.g. a hearing instrument adapted for being located at the ear or fully or partially in the ear canal of a user.

According to a third aspect of the present disclosure, a tangible computer-readable medium storing a computer program comprising program code instructions for causing a data processing system to perform the method according to the second aspect of invention is provided.

By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Other storage media include storage in DNA (e.g. in synthesized DNA strands). Combinations of the above should also be included within the scope of computer-readable media. In addition to being stored on a tangible medium, the computer program can also be transmitted via a transmission medium such as a wired or wireless link or a network, e.g. the Internet, and loaded into a data processing system for being executed at a location different from that of the tangible medium. </mention relevant parts of the method that may be implemented in software; if not all/>

According to a fourth aspect of the present disclosure, a computer program comprising instructions for causing a data processing system to perform the method according to the second aspect of invention is provided.

According to a fifth aspect of the present disclosure, a data processing system comprising a processor and program code means for causing the processor to perform the method according to the second aspect is provided.

In a sixth aspect of the present disclosure, a hearing system comprising a hearing aid as described above, in the ‘detailed description of embodiments’, and in the claims, and an auxiliary device is moreover provided.

The hearing system may be adapted to establish a communication link between the hearing aid and the auxiliary device to provide that information (e.g. control and status signals, possibly audio signals) can be exchanged or forwarded from one to the other.

The auxiliary device may be constituted by or comprise a remote control, a smartphone, or other portable or wearable electronic device, such as a smartwatch or the like.

The auxiliary device may be constituted by or comprise a remote control for controlling functionality and operation of the hearing aid(s). The function of a remote control may be implemented in a smartphone, the smartphone possibly running an APP allowing to control the functionality of the audio processing device via the smartphone (the hearing aid(s) comprising an appropriate wireless interface to the smartphone, e.g. based on Bluetooth or some other standardized or proprietary scheme).

The auxiliary device may be constituted by or comprise an audio gateway device adapted for receiving a multitude of audio signals (e.g. from an entertainment device, e.g. a TV or a music player, a telephone apparatus, e.g. a mobile telephone or a computer, e.g. a PC, a wireless microphone, etc.) and adapted for selecting and/or combining an appropriate one of the received audio signals (or combination of signals) for transmission to the hearing aid.

The auxiliary device may be constituted by or comprise another hearing aid. The hearing system may comprise two hearing aids adapted to implement a binaural hearing system, e.g. a binaural hearing aid system.

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears and/or acoustic signals transferred as mechanical vibrations to the user's inner ears through the bone structure of the user's head and/or through parts of the middle ear.

The hearing aid may be configured to be worn in any known way, e.g. as a unit arranged behind the ear with a tube leading radiated acoustic signals into the ear canal or with an output interface transducer, e.g. a loudspeaker, arranged close to or in the ear canal, as a unit entirely or partly arranged in the pinna and/or in the ear canal, as a unit, e.g. a vibrator, attached to a fixture implanted into the skull bone, etc. The hearing aid may comprise a single unit or several units communicating (e.g. acoustically, electrically or optically) with each other. The loudspeaker may be arranged in a housing together with other components of the hearing aid, or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system), and used by a processing algorithm executed by the configurable signal processing circuit of the hearing aid.

A ‘hearing system’ refers to a system comprising one or two hearing aids, and a ‘binaural hearing system’ refers to a system comprising two hearing aids and being adapted to cooperatively provide audible signals to both of the user's ears. Hearing systems or binaural hearing systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g. a music player, a wireless communication device, e.g. a mobile phone (such as a smartphone) or a tablet or another device, e.g. comprising a graphical interface. Hearing aids, hearing systems or binaural hearing systems may e.g. be used for compensating for a hearing-impaired person's loss of hearing capability, augmenting or protecting a normal-hearing person's hearing capability and/or conveying electronic audio signals to a person. Hearing aids or hearing systems may e.g. form part of or interact with public-address systems, active ear protection systems, handsfree telephone systems, car audio systems, entertainment (e.g. TV, music playing or karaoke) systems, teleconferencing systems, classroom amplification systems, etc.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 shows a block diagram of signal processing performed by a hearing aid according to an embodiment according to the present disclosure; and

FIG. 2 shows a block diagram of signal processing performed by a hearing according to another embodiment according to the present disclosure.

FIG. 3 shows a block diagram of signal processing performed by a hearing according to yet another embodiment according to the present disclosure.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

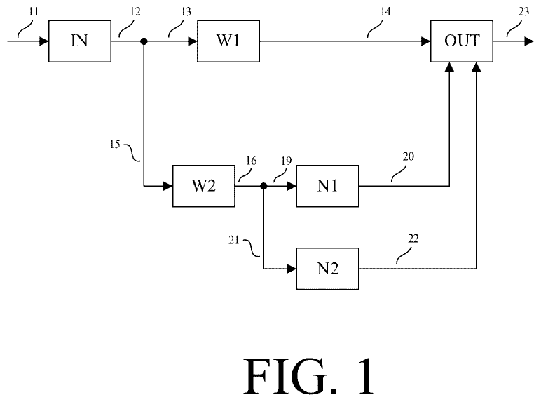

FIG. 1 shows a block diagram of signal processing performed by a hearing aid according to an embodiment according to the present disclosure. The hearing aid comprises an input interface IN. The input interface IN is configured to provide a plurality of input audio signals 12. The input interface IN may obtain the plurality of input audio signal 12 via a wireless link with another device. The input interface IN may comprise one or more microphones and is configured to convert an acoustic signal 11 to the plurality of input audio signals 12.

The hearing aid comprises a first beamformer W1. The first beamformer W1 is configured to receive a first beamformer input signal 13 based on the plurality of input audio signals 12. The first beamformer input signal may be the plurality of input audio signals 12, or a processed version of the plurality of input audio signals 12. The first beamformer W1 is configured to determine a first beamformed signal 14 based on the first beamformer input signal 13. The first beamformer W1 may determine the first beamformed signal 14 by performing beamforming on the first beamformer input signal 13. Beamforming performed by the first beamformer W1 may be done based on a distortion-less criteria. The first beamformed signal 14 may be viewed as a distortion-less signal comprising both a target signal and a noise signal, where the target signal is the desired signal and the noise signal constitutes parts desired to be minimized and/or removed, such as background noise, transient noise, interfering speech, or other undesired signals.

The hearing aid comprises a second beamformer W2. The second beamformer W2 is configured to receive a second beamformer input signal 15 based on the plurality of input audio signals 12. The second beamformer input signal 15 may be the plurality of input audio signals 12 or a processed version of the plurality of input audio signals 12. The second beamformer W2 is configured to determine a second beamformed signal 16 based on the second beamformer input signal 15. The second beamformer W2 may determine the second beamformed signal 16 by performing beamforming on the second beamformer input signal 15. Beamforming performed by the second beamformer W2 may be done with the second beamformer W2 acting as a target canceller beamformer, where the second beamformed signal is determined by minimizing a power of a target in the second beamformer input signal 15. The second beamformed signal 16 may be viewed as a target-less signal comprising a noise signal, the noise signal in return may be viewed as comprising noise corresponding to different types of noise, e.g., high-modulated noise, or constant background noise.

The hearing aid comprises a first noise canceller N1. The first noise canceller N1 is configured to receive a first noise canceller input signal 18 based on the second beamformed signal 16. The first noise canceller input signal 18 may be the second beamformed signal 16, or a processed version of the second beamformed signal 16. The first noise canceller N1 is configured to determine a first anti-noise signal 20 based on the first noise canceller input signal 18. The first anti-noise signal 20 is an anti-noise signal for a first type of noise. The first noise canceller N1 may be a noise canceller specialized in slowly modulated noise, such as constant background noise. The first noise canceller N1 may be configured to filter the second beamformed signal 16 according to a set of first filter coefficients to thereby get the first anti-noise signal 20. The first anti-noise signal 20 may be viewed as a noise signal representing the first type of noise in the plurality of input audio signals 12. The first noise canceller N1 is configured to output the first anti-noise signal 20.

The hearing aid comprises a second noise canceller N2. The second noise canceller N2 is configured to receive a second noise canceller input signal 21 based on the second beamformed signal 16. The second noise canceller input signal 21 may be the second beamformed signal 16, or a processed version of the second beamformed signal 16. The second noise canceller N2 is configured to determine a second anti-noise signal 22 based on the second noise canceller input signal 21. The second anti-noise signal 22 is an anti-noise signal for a second type of noise. The second noise canceller N2 may be a noise canceller specialized in highly modulated noise, such as speech or other transient noise. The second noise canceller N2 may be configured to filter the second beamformed signal 16 according to a set of second filter coefficients to thereby get the second anti-noise signal 22. The second anti-noise signal 22 may be viewed as a noise signal representing the second type of noise in the plurality of input audio signals 12.

The hearing aid comprises an output interface OUT. The output interface OUT is configured to determine an output signal 23 based on the first beamformed signal 14, the first anti-noise signal 20, and the second anti-noise signal 22. The output interface OUT may be configured to determine the output signal 23 as a linear combination of the first beamformed signal 14, the first anti-noise signal 20, and the second anti-noise signal 22. The output interface OUT may be configured to subtract the first anti-noise signal 20, and the second anti-noise signal 22 from the second beamformed signal 14 to determine the output signal 23. The output interface OUT is configured to output the output signal 23. The output interface OUT may output the output signal 23 for further processing. The output interface OUT may output the output signal 23 to one or more output transducers for it to be converted to sound for a user of the hearing aid.

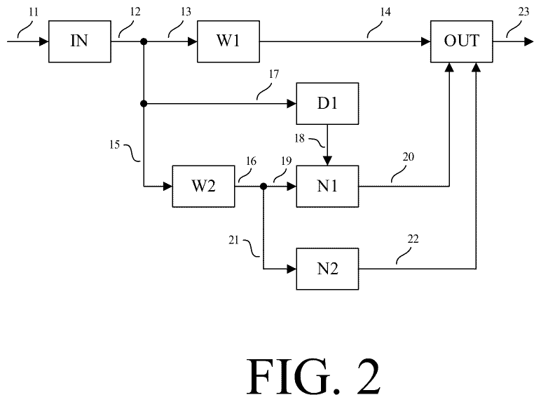

FIG. 2 shows a block diagram of signal processing performed by a hearing aid according to an embodiment according to the present disclosure. The hearing aid comprises an input interface IN. The input interface IN is configured to provide a plurality of input audio signals 12. The input interface IN may obtain the plurality of input audio signal 12 via a wireless link with another device. The input interface IN may comprise one or more microphones and is configured to convert an acoustic signal 11 to the plurality of input audio signals 12.

The hearing aid comprises a first beamformer W1. The first beamformer W1 is configured to receive a first beamformer input signal 13 based on the plurality of input audio signals 12. The first beamformer input signal may be the plurality of input audio signals 12, or a processed version of the plurality of input audio signals 12. The first beamformer W1 is configured to determine a first beamformed signal 14 based on the first beamformer input signal 13. The first beamformer W1 may determine the first beamformed signal 14 by performing beamforming on the first beamformer input signal 13. Beamforming performed by the first beamformer W1 may be done based on a distortion-less criteria. The first beamformed signal 14 may be viewed as a distortion-less signal comprising both a target signal and a noise signal, where the target signal is the desired signal and the noise signal constitutes parts desired to be minimized and/or removed, such as background noise, transient noise, interfering speech, or other undesired signals.

The hearing aid comprises a first detector D1. The first detector is configured to receive a first detector input signal 17 based on the plurality of input audio signals 12. In the present embodiment the first detector D1 receives the plurality of input audio signals 12, in other embodiment the first detector D1 may receive a processed version of the plurality of audio signals 12. The first detector D1 is configured to determine a first audio parameter based on the first detector input signal 17. The first detector D1 may be a voice activity detector and the first audio parameter may be a voice activity parameter, e.g. a speech presence probability, or an own-voice speech presence probability. The first detector D1 is configured to determine a first detector output signal 18 based on the determined first audio parameter. The first detector output signal 18 may be determined as comprising the first audio parameter or a processed version of the first audio parameter.

The hearing aid comprises a second beamformer W2. The second beamformer W2 is configured to receive a second beamformer input signal 15 based on the plurality of input audio signals 12. The second beamformer input signal 15 may be the plurality of input audio signals 12 or a processed version of the plurality of input audio signals 12. The second beamformer W2 is configured to determine a second beamformed signal 16 based on the second beamformer input signal 15. The second beamformer W2 may determine the second beamformed signal 16 by performing beamforming on the second beamformer input signal 15. Beamforming performed by the second beamformer W2 may be done with the second beamformer W2 acting as a target canceller beamformer, where the second beamformed signal is determined by minimizing a power of a target in the second beamformer input signal 15. The second beamformed signal 16 may be viewed as a target-less signal comprising a noise signal, the noise signal in return may be viewed as comprising noise corresponding to different types of noise, e.g., high-modulated noise, or constant background noise.

The hearing aid comprises a first noise canceller N1. The first noise canceller N1 is configured to receive a first noise canceller input signal 18, 19 based on the second beamformed signal 16 and the first detector output signal 18. The first noise canceller input signal 18, 19 may be the second beamformed signal 16 and the first detector output signal 18, or processed versions of the second beamformed signal 16 and the first detector output signal 18. The first noise canceller N1 is configured to determine a first anti-noise signal 20 based on the first noise canceller input signal 18, 19. The first anti-noise signal 20 is an anti-noise signal for a first type of noise. The first noise canceller N1 may be a noise canceller specialized in slowly modulated noise, such as constant background noise. The first noise canceller N1 may be activated in dependence of the detector output signal 18, e.g., if the detector only or mainly detects noise of a second noise type it may be preferable to fix the first noise canceller N1 as the first noise canceller N1 is adapted for the first type of noise. Alternatively, if the detector detects noise of the first type it may be preferable to allow the first noise canceller to adapt to the noise. The first noise canceller N1 may be configured to filter the second beamformed signal 16 according to a set of first filter coefficients to thereby get the first anti-noise signal 20. Consequently, the first detector output signal 18 may be viewed as a control signal controlling operation of the first noise canceller, and the second beamformed signal 19 may be viewed as the signal to be filtered by the first noise canceller N1 to obtain the first anti-noise signal 20. The first anti-noise signal 20 may be viewed as a noise signal representing the first type of noise in the plurality of input audio signals 12. The first noise canceller N1 is configured to output the first anti-noise signal 20.

The hearing aid comprises a second noise canceller N2. The second noise canceller N2 is configured to receive a second noise canceller input signal 21 based on the second beamformed signal 16. The second noise canceller input signal 21 may be the second beamformed signal 16, or a processed version of the second beamformed signal 16. The second noise canceller N2 is configured to determine a second anti-noise signal 22 based on the second noise canceller input signal 21. The second anti-noise signal 22 is an anti-noise signal for a second type of noise. The second noise canceller N2 may be a noise canceller specialized in highly modulated noise, such as speech or other transient noise. The second noise canceller N2 may be configured to filter the second beamformed signal 16 according to a set of second filter coefficients to thereby get the second anti-noise signal 22. The second anti-noise signal 22 may be viewed as a noise signal representing the second type of noise in the plurality of input audio signals 12.

The hearing aid comprises an output interface OUT. The output interface OUT is configured to determine an output signal 23 based on the first beamformed signal 14, the first anti-noise signal 20, and the second anti-noise signal 22. The output interface OUT may be configured to determine the output signal 23 as a linear combination of the first beamformed signal 14, the first anti-noise signal 20, and the second anti-noise signal 22. The output interface OUT may be configured to subtract the first anti-noise signal 20, and the second anti-noise signal 22 from the second beamformed signal 14 to determine the output signal 23. The output interface OUT is configured to output the output signal 23. The output interface OUT may output the output signal 23 for further processing. The output interface OUT may output the output signal 23 to one or more output transducers for it to be converted to sound for a user of the hearing aid.

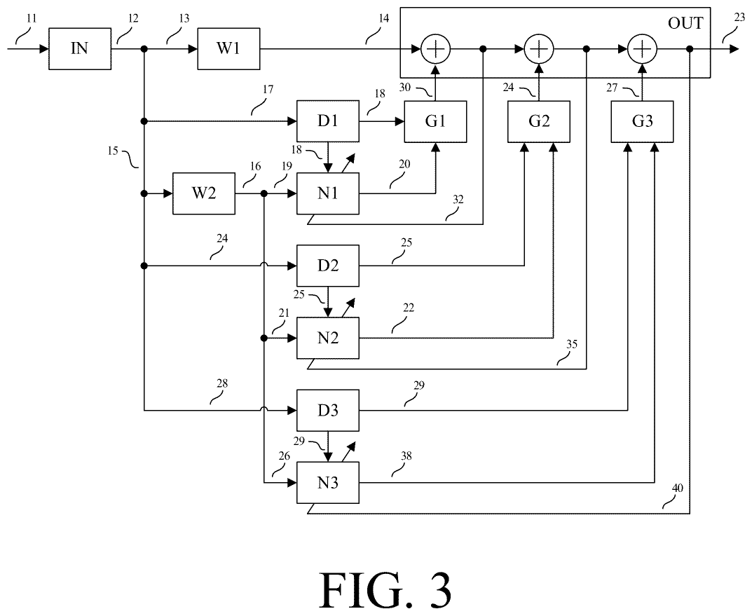

Referring to FIG. 3 shows a block diagram of signal processing performed by a hearing aid according to another embodiment according to the present disclosure. The hearing aid comprises an input interface IN. The input interface IN is configured to provide a plurality of input audio signals 12. The input interface IN may obtain the plurality of input audio signal 12 via a wireless link with another device. The input interface IN in the present embodiment comprises two or more microphones and is configured to convert an acoustic signal 11 to the plurality of input audio signals 12. The plurality of input audio signals 12 may be modeled as

$$x ( k , n ) = s ( k , n ) d ( k , n ) + ν ( k , n ) ,$$

where s(k,n) is the desired signal at the reference microphone (e.g. the front microphone on a hearing aid), d(k,n) is the relative transfer function (RTF) vector (encoding the relative acoustics between the microphones to the reference microphone), and v(k,n) is the noise vector.

Typically, the minimum variance distortions-less response (MVDR) beamformer is used to suppress v(k,n). The MVDR beamformer is a linear combination of x(k,n) which minimizes the noise power at the output of the beamformer and is constrained to have a distortion-less response on the desired signal RTF vector. The output of the MVDR beamformer may be formulated as

$$y ( k , n ) = {w}_{MVDR}^{H} ( k , n ) x ( k , n ) ,$$

where H is the complex conjugate transpose of a vector. w_{MVDR}(k,n) is the vector of MVDR beamformer weights. The MVDR beamformer weights may be found using the Generalized Sidelobe Canceller (GSC) structure, for a two microphone example, the beamformer weights may be expressed as:

$${w}_{MVDR}^{H} ( k , n ) = {w}_{DSB} ( k , n ) - {w}_{TC} ( k , n ) β ( k , n ) ,$$

where w_{DSB}(k,n) is the delay-and-sum beamformer weights or any beamformer with a distortion-less constraint on the desired signal RTF vector, w_{TC}(k,n) is the target cancelling beamformer weights, and β(k,n) is a noise canceller. The output of the MVDR beamformer may therefore be expressed as

$$y ( k , n ) = {w}_{DSB}^{H} ( k , n ) x ( k , n ) - β * ( k , n ) {w}_{TC}^{H} ( k , n ) x ( k , n ) ,$$

where * is the complex conjugate operator. In the present embodiment hearing aid comprises a first beamformer W1. The first beamformer W1 is configured to receive a first beamformer input signal 13 based on the plurality of input audio signals 12. The first beamformer input signal may be the plurality of input audio signals 12, or a processed version of the plurality of input audio signals 12. The first beamformer W1 is configured to determine a first beamformed signal 14 based on the first beamformer input signal 13. The first beamformer W1 in the present embodiment is a beamformer with a distortion-less criteria. In other words, the first beamformed signal may be formulated as

$${y}_{DSB} ( k , n ) = {W}_{DSB}^{H} ( k , n ) x ( k , n ) ,$$

or at least a processed version thereof.

The hearing aid comprises a second beamformer W2. The second beamformer W1 is configured to receive a second beamformer input signal 15 based on the plurality of input audio signals 12. The second beamformer input signal 15 may be the plurality of input audio signals 12 or a processed version of the plurality of input audio signals 12. The second beamformer W2 is configured to determine a second beamformed signal 16 based on the second beamformer input signal 15. The second beamformer is a target cancelling beamformer configured to determine the second beamformed signal based on minimizing power of a target based on the plurality of input audio signals. In other words, the second beamformed signal may be formulated as

$${y}_{tc} ( k , n ) = {w}_{TC}^{H} ( k , n ) x ( k , n ) ,$$

or at least a processed version thereof.

The hearing aid comprises a first detector D1. The first detector D1 is configured to receive a first detector input signal 17 based on the plurality of input audio signals 12. In the present embodiment the first detector D1 receives the plurality of input audio signals 12, in other embodiment the first detector D1 may receive a processed version of the plurality of audio signals 12. The first detector D1 is configured to determine a first audio parameter based on the first detector input signal 17. The first audio parameter is a voice activity parameter. For example, the first detector D1 may be a voice activity detector or an own-voice activity detector. The first detector D1 is configured to determine a first detector output signal 18 based on the determined first audio parameter. The first detector D1 is configured to compare the first audio parameter to a first threshold, if the first audio parameter exceeds the first threshold, determining the first detector output signal 18 as comprising an activation signal allowing a first noise canceller N1 to adapt by reducing an error between the first anti-noise signal 20 and a first target signal 14 based on the first beamformed signal 14, and if the first audio parameter does not exceed the first threshold, determining the first detector output signal 18 as comprising a fixing signal fixing the first noise canceller N1. For example, if the first noise canceller N1 was configured to handle slow time varying noise, such as background noise, the first detector D1 may be configured to activate the first noise canceller N1 if no or low voice activity is detected, and fix the first noise canceller N1 in situations with a high voice activity.

The hearing aid comprises a second detector D2. The second detector D2 is configured to receive a second detector input signal 24 based on the plurality of input audio signals 12. In the present embodiment the second detector D2 receives the plurality of input audio signals 12, in other embodiment the second detector D2 may receive a processed version of the plurality of audio signals 12. The second detector D2 is configured to determine a second audio parameter based on the second detector input signal 24. The second audio parameter is an interference activity parameter. For example, the second detector D2 may be a distractor detector configured to detect highly modulated noise. The second detector D2 is configured to determine a second detector output signal 25 based on the determined second audio parameter. The second detector D2 is configured to compare the second audio parameter to a second threshold, if the second audio parameter exceeds the second threshold, determining the second detector output signal 25 as comprising an activation signal allowing a second noise canceller N2 to adapt by reducing an error between the second anti-noise signal 22 and a second target signal based on the first beamformed signal 14, and if the second audio parameter does not exceed the second threshold, determining the second detector output signal 25 as comprising a fixing signal fixing the second noise canceller N2. For example, if the second noise canceller N2 was configured to handle fast time varying noise, such as speech, the second detector D2 may be configured to activate the second noise canceller N2 if interfering speech is detected, and fix the second noise canceller N2 in situations with no fast time varying noise.

The hearing aid comprises a third detector D3. The third detector is configured to receive a third detector input signal 28 based on the plurality of input audio signals 12. In the present embodiment the third detector D3 receives the plurality of input audio signals 12, in other embodiment the third detector D3 may receive a processed version of the plurality of audio signals 12. The third detector D3 is configured to determine a third audio parameter based on the third detector input signal 28. The third audio parameter is an audio feedback parameter. For example, the third detector D3 may be a feedback detector configured to detect feedback. The third detector D3 is configured to determine a third detector output signal 29 based on the determined third audio parameter. The third detector D3 is configured to compare the third audio parameter to a third threshold, if the third audio parameter exceeds the third threshold, determining the third detector output signal 29 as comprising an activation signal allowing a third noise canceller N3 to adapt by reducing an error between the third anti-noise signal 22 and a third target signal based on the first beamformed signal 14, and if the third audio parameter does not exceed the third threshold, determining the third detector output signal 29 as comprising a fixing signal fixing the third noise canceller N3. For example, if the third noise canceller N3 was configured to handle feedback the third detector D3 may be configured to activate the third noise canceller N3 if feedback is detected and fix the third noise canceller N3 in situations with no detected feedback.

In the present embodiment multiple specialized noise cancellers N1, N2, and N3 are utilized. Where the first noise canceller N1 is specialized in attenuating slowly time-varying background noise, the second noise canceller N2 is specialized in cancelling highly modulated distractors from one or more specific directions, and the third noise canceller N3 is specialized in cancelling feedback. The division of the noise cancellers N1, N2 and D3 into multiple parts allows for specialized control over each individual noise canceller. This is achieved by using different detectors D1, D2, and D3, smoothing factors, and gains G1, G2 and G3 applied at the output of each noise canceller N1, N2 and N3. In the presented multi-stage noise cancelling structure, there are I number of noise reference signals and I number of target outputs. The noise reference signals may be defined as:

$${y}_{vref , i} ( k , n ) = {β}_{i}^{*} ( k , n ) {y}_{tc} ( k , n ) ,$$

where the index i refers to the i'th noise reference signal. The target outputs are given as

$${y}_{trg , i} ( k , n ) = {y}_{trg , i - 1} ( k , n ) - {y}_{vref , i} ( k , n ) ,$$

$${y}_{trg , i} ( k , n ) = {y}_{trg , i - 1} ( k , n ) - {β}_{i}^{*} ( k , n ) {y}_{tc} ( k , n ) ,$$

$${y}_{trg , i} ( k , n ) = {y}_{DSB} ( k , n ) - {y}_{tc} ( k , n ) {\sum }_{j = 1}^{i} {β}_{j}^{*} ( k , n ) ,$$

where y_{trg,i-1}(k,n)=y_{DSB}(k,n) if i=1. In principle, the noise cancellers can be collected and represented with a single noise canceller value:

$$β ( k , n ) = {\sum }_{j = 1}^{i} {β}_{j}^{*} ( k , n ) .$$

To compute each individual noise canceller, the noise cancellers need to be computed in sequence starting with β₁(k,n), since each noise canceller is dependent on the previous noise canceller. The computation of each noise canceller may in a two microphone system be expressed as follows:

$${β}_{i} ( k , n ) = \{ \begin{matrix}\frac{{α}_{i} {E}_{{y}_{trg , i - 1}^{*} {y}_{tc}} ( k , n - 1 ) + ( 1 - {α}_{i} ) {y}_{trg , i - 1}^{*} ( k , n ) {y}_{tc} ( k , n )}{{α}_{i} {E}_{{\vert {y}_{tc} \vert}^{2}} ( k , n - 1 ) + ( 1 - {α}_{i} ) {\vert {y}_{tc} ( k , n ) \vert}^{2}} , & if {Detector}_{i} = 1 \\ {β}_{i} ( k , n - 1 ) , & if {Detector}_{i} = 0\end{matrix}$$

where aᵢ is the i'th smoothing factor,

$${E}_{{y}_{DSB}^{*} {y}_{trg , i - 1}^{*} {y}_{tc}} ( k , n ) = {{y}_{DS}^{*}}_{{y}_{trg , i - 1}^{*}} ( k , n ) {y}_{tc} ( k , n ) > and {E}_{{\vert {y}_{tc} \vert}^{2}} ( k , n ) = < {\vert {y}_{tc} ( k , n ) \vert}^{2} > .$$

where the operator <⋅> refers to first order recursive smoothing i.e.,

$$< x > {=}^{Δ} {E}_{x} ( k , n ) = a {E}_{x} ( k , n - 1 ) + ( 1 - a ) x ,$$

Each noise canceller can also be approximated using an iterative solver instead of the closed-form solution. One commonly used iterative solver is a gradient descent method, expressed as follows:

$${β}_{i} ( k , n + 1 ) = {β}_{i} ( k , n ) + {μ}_{i} {y}_{trg , i}^{*} ( k , n ) {y}_{tc} ( k , n ) ,$$

where μᵢ is a step size, and

$${y}_{trg , i} ( k , n ) = {y}_{trg , i - 1} ( k , n ) - {β}_{i}^{*} ( k , n ) {y}_{tc} ( k , n ) .$$

The hearing aid comprises a first noise canceller N1. The first noise canceller N1 is configured to receive a first noise canceller input signal 18, 19 based on the second beamformed signal 16 and the first detector output signal 18. The first noise canceller input signal 18, 19 may be the second beamformed signal 16 and the first detector output signal 18, or processed versions of the second beamformed signal 16 and the first detector output signal 18. The first noise canceller N1 is configured to determine a first anti-noise signal 20 based on the first noise canceller input signal 18, 19. The first anti-noise signal 20 is an anti-noise signal for a first type of noise. The first noise canceller N1 may be formulated as

$${β}_{1} ( k , n ) = \{ \begin{matrix}\frac{{α}_{1} {E}_{{y}_{trg , 1 - 1}^{*} {y}_{tc}} ( k , n - 1 ) + ( 1 - {α}_{i} ) {y}_{trg , 1 - 1}^{*} ( k , n ) {y}_{tc} ( k , n )}{{α}_{1} {E}_{{\vert {y}_{tc} \vert}^{2}} ( k , n - 1 ) + ( 1 - {α}_{1} ) {\vert {y}_{tc} ( k , n ) \vert}^{2}} , & if {Detector}_{i} = activation \\ {β}_{i} ( k , n - 1 ) , & if {Detector}_{i} = fixing\end{matrix}$$

The first noise canceller N1 may be a noise canceller specialized in slowly modulated noise, such as constant background noise. The first noise canceller N1 may be activated in dependence of the first detector output signal 18, e.g., if the detector only or mainly detects noise of a second noise type it may be preferable to fix the first noise canceller N1 as the first noise canceller N1 is adapted for the first type of noise. Alternatively, if the first detector D1 detects noise of the first type it may be preferable to allow the first noise canceller to adapt to the noise. The first noise canceller N1 may be configured to filter the second beamformed signal 16 according to a set of first filter coefficients to thereby get the first anti-noise signal 20. Consequently, the first detector output signal 18 may be viewed as a control signal controlling operation of the first noise canceller N1, and the second beamformed signal 19 may be viewed as the signal to be filtered by the first noise canceller N1 to obtain the first anti-noise signal 20. The first anti-noise signal 20 may be viewed as a noise signal representing the first type of noise in the plurality of input audio signals 12. The first noise canceller N1 comprises a first smoothing factor. The smoothing factors of a noise canceller may define the adaptation rate of the associated noise canceller. The first noise canceller N1 is configured to output the first anti-noise signal 20.

The hearing aid comprises a second noise canceller N2. The second noise canceller N2 is configured to receive a second noise canceller input signal 21 based on the second beamformed signal 16. The second noise canceller input signal 21 may be the second beamformed signal 16, or a processed version of the second beamformed signal 16. The second noise canceller N2 is configured to determine a second anti-noise signal 22 based on the second noise canceller input signal 21. The second anti-noise signal 22 is an anti-noise signal for a second type of noise. The second noise canceller N2 may be a noise canceller specialized in highly modulated noise, such as speech or other transient noise. The second noise canceller N2 may be activated in dependence of the second detector output signal 25, e.g., if the detector only or mainly detects noise of a second noise type it may be preferable to fix the second noise canceller N2 as the second noise canceller N2 is adapted for the second type of noise. Alternatively, if the second detector D2 detects noise of the second type it may be preferable to allow the second noise canceller N2 to adapt to the noise. The second noise canceller N2 may be configured to filter the second beamformed signal 16 according to a set of second filter coefficients to thereby get the second anti-noise signal 22. Consequently, the second detector output signal 25 may be viewed as a control signal controlling operation of the second noise canceller N2, and the second beamformed signal 19 may be viewed as the signal to be filtered by the second noise canceller N2 to obtain the second anti-noise signal 22. The second anti-noise signal 22 may be viewed as a noise signal representing the second type of noise in the plurality of input audio signals 12. The second noise canceller N2 is configured to output the second anti-noise signal 22. The second noise canceller N2 comprises a second smoothing factor. The first smoothing factor results in a lower adaptation rate than the second smoothing factor.

The hearing aid comprises a third noise canceller N3. The third noise canceller N3 is configured to receive a third noise canceller input signal 26 based on the second beamformed signal 16. The third noise canceller input signal 26 may be the second beamformed signal 16, or a processed version of the second beamformed signal 16. The third noise canceller N3 is configured to determine a third anti-noise signal 38 based on the third noise canceller input signal 26. The third anti-noise signal 38 is an anti-noise signal for a third type of noise. The third noise canceller N3 may be a noise canceller specialized in reducing noise due to feedback, such as echo, or mechanical feedback noise. The third noise canceller N3 may be activated in dependence of the third detector output signal 29, e.g., if the detector only or mainly detects noise of a second noise type it may be preferable to fix the third noise canceller N3 as the third noise canceller N3 is adapted for the third type of noise. Alternatively, if the third detector D3 detects noise of the third type it may be preferable to allow the third noise canceller N3 to adapt to the noise. The third noise canceller N3 may be configured to filter the second beamformed signal 16 according to a set of third filter coefficients to thereby get the third anti-noise signal 38. Consequently, the third detector output signal 29 may be viewed as a control signal controlling operation of the third noise canceller N3, and the second beamformed signal 16 may be viewed as the signal to be filtered by the third noise canceller N3 to obtain the third anti-noise signal 38. The third anti-noise signal 38 may be viewed as a noise signal representing the third type of noise in the plurality of input audio signals 12. The third noise canceller N3 is configured to output the third anti-noise signal 38.

The hearing aid comprises a first gain controller G1. The first gain controller G1 is configured to receive the first anti-noise signal 20, determine a first control gain, apply the first control gain to the first anti-noise signal 20, and output a first noise-controlled signal 30. The first control gain may be a predetermined gain set by a sound engineer, an audiologist, or a user of the hearing aid. In the present embodiment the first control gain is an adaptive gain determined based on the first detector output signal 18. The first control gain may be determined as a function of the first audio parameter determined by the first detector D1. For example, the first audio parameter may be determined as a speech presence probability of 0.9, then the first control gain may be set as a global gain of 0.9.

The hearing aid comprises a second gain controller G2. The second gain controller G2 is configured to receive the second anti-noise signal 22, determine a second control gain, apply the second control gain to the second anti-noise signal 22, and output a second noise-controlled signal 24. The second control gain may be a predetermined gain set by a sound engineer, an audiologist, or a user of the hearing aid. In the present embodiment the second control gain is an adaptive gain determined based on the second detector output signal 25. The second control gain may be determined as a function of the second audio parameter determined by the second detector D2. For example, the second audio parameter may be determined as an interference presence probability of 0.9, then the second control gain may be set as a global gain of 0.9.

The hearing aid comprises a third gain controller G3. The third gain controller G3 is configured to receive the third anti-noise signal 28, determine a third control gain, apply the third control gain to the third anti-noise signal 28, and output a third noise-controlled signal 27. The third control gain may be a predetermined gain set by a sound engineer, an audiologist, or a user of the hearing aid. In the present embodiment the third control gain is an adaptive gain determined based on the third detector output signal 29. The third control gain may be determined as a function of the third audio parameter determined by the third detector D2. For example, the third audio parameter may be determined as a feedback probability of 0.9, then the third control gain may be set as a global gain of 0.9.

In the present embodiment the first beamformer W1 and the second beamformer W2 are fixed filters, and the first noise canceller N1, the second noise canceller N2 and the third noise canceller N3 are adaptive filters. The first noise canceller N1 is adapted according to a first error signal 32. The first error signal 32 may be determined by an output interface OUT. The output interface OUT may determine the first error signal 32 by subtracting the first noise-controlled signal 20 from the first beamformed signal 14. The second noise canceller N2 is adapted according to a second error signal 35. The second error signal 35 may be determined by an output interface OUT. The output interface OUT may determine the second error signal 35 by subtracting the second noise-controlled signal 20 from the first error signal 32. The third noise canceller N3 is adapted according to a third error signal 40. The third error signal 40 may be determined by an output interface OUT. The output interface OUT may determine the third error signal 40 by subtracting the third noise-controlled signal 27 from the second error signal 35.

The hearing aid comprises an output interface OUT. The output interface OUT is configured to determine an output signal 23 based on the first beamformed signal 14, the first noise-controlled signal 20, the second noise-controlled signal 24, and the third noise-controlled signal 27. The output interface OUT is configured to determine the output signal 23 as a linear combination of the first beamformed signal 14, the first noise-controlled signal 20, the second noise-controlled signal 24, and the third noise-controlled signal 27. The output interface OUT is configured to subtract the first noise-controlled signal 20, the second noise-controlled signal 24, and the third noise-controlled signal 27 from the second beamformed signal 14 to determine the output signal 23. The output interface OUT is configured to output the output signal 23. The output interface OUT may output the output signal 23 for further processing. The output interface OUT may output the output signal 23 to one or more output transducers for it to be converted to sound for a user of the hearing aid.

The hearing aid presented in connection with FIGS. 1, 2 and 3 may comprise an air-conduction type hearing aid, a bone-conduction type hearing aid, or a combination thereof.

The term ‘or a processed version thereof’ may e.g. cover such extracted features from an original audio signal. The term ‘or a processed version thereof’ may e.g. also cover an original audio signal that has been subject to a processing algorithm that applies gain or attenuation and/or delay to the original audio signal and this results in a modified audio signal (preferably enhanced in some sense, e.g. noise reduced relative to a target signal, or simply delayed).

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

### ENUMERATED LIST OF ITEMS

Examples of hearing aids, systems, and methods according to the present disclosure are set out in the following items:
Item 1. hearing aid comprising:
   an input interface configured to provide a plurality of input audio signals,
   a first beamformer configured to receive a first beamformer input signal based on the plurality of input audio signals, and determine a first beamformed signal based on the first beamformer input signal,
   a second beamformer configured to receive a second beamformer input signal based on the plurality of input audio signals, and determine a second beamformed signal based on the second beamformer input signal,
   a first detector configured to receive a first detector input signal based on the plurality of input audio signals, determine a first audio parameter based on the first detector input signal, determine a first detector output signal based on the determined first audio parameter, and output the first detector output signal,
   a first noise canceller configured to receive a first noise canceller input signal based on the second beamformed signal and the first detector output signal, determine a first anti-noise signal based on the first noise canceller input signal, wherein the first anti-noise signal is an anti-noise signal for a first type of noise, and output the first anti-noise signal,
   a second noise canceller configured to receive a second noise canceller input signal based on the second beamformed signal, determine a second anti-noise signal based on the second beamformed signal, wherein the second anti-noise signal is an anti-noise signal for a second type of noise, and output a second anti-noise signal,
   an output interface configured to determine an output signal based on the first beamformed signal, the first anti-noise signal, and the second anti-noise signal, and output the output signal.
Item 2. A hearing aid according to Item 1, wherein the input interface comprises two or more microphones configured to provide the plurality of input audio signals.
Item 3. A hearing aid according to items 1 or 2, wherein the first beamformer and the second beamformer are fixed filters, and wherein the first noise canceller and the second noise canceller are adaptive filters.
Item 4. A hearing aid according to any of items 1 to 3, wherein the first type of noise is a slow time-varying noise, and wherein the second type of noise is a fast time-varying noise.
Item 5. A hearing aid according to any of items 1-4, wherein the first noise canceller comprises a first smoothing factor, wherein the second noise canceller comprises a second smoothing factor, wherein the smoothing factors defines the adaptation rate of the associated noise canceller, wherein the first smoothing factor results in a lower adaptation rate than the second smoothing factor.
Item 6. A hearing aid according to any of items 1-5, wherein determining the first detector output signal comprises comparing the first audio parameter to a first threshold,
   if the first audio parameter exceeds the first threshold, determining the first detector output signal as comprising an activation signal allowing the first noise canceller to adapt by reducing an error between the first anti-noise signal and a first target signal based on the first beamformed signal, and
   if the first audio parameter does not exceed the first threshold, determining the first detector output signal as comprising a fixing signal fixing the first noise canceller.
Item 7. A hearing aid according to any of items 1-6 comprising a second detector configured to receive a second detector input signal based on the plurality of input audio signals, determine a second audio parameter based on the second detector input signal, determine a second detector output signal based on the determined second audio parameter, and output the second detector output signal,
   wherein the second noise canceller is configured to receive the second detector output signal, and determine the second anti-noise signal based on the second detector output signal.
Item 8. A hearing aid according to any of item 1-7, wherein determining the second detector output signal comprises comparing the second audio parameter to a second threshold,
   if the second audio parameter exceeds the second threshold, determining the second detector output signal as comprising an activation signal allowing the second noise canceller to adapt by reducing an error between a second target signal based on the first beamformed signal and the second anti-noise signal and the second noise canceller input signal, and
   if the second audio parameter does not exceed the second threshold, determining the second detector output signal as comprising a fixing signal fixing the second noise canceller.
Item 9. A hearing aid according to items 7 or 8, wherein the second audio parameter is an interference activity parameter.
Item 10. A hearing aid according to items 1-9, wherein the first audio parameter is a voice activity parameter.
Item 11. A hearing aid according to any of items 1-10 comprising:
   a first gain controller configured to receive the first anti-noise signal, determine a first control gain, apply the first control gain to the first anti-noise signal, and output a first noise-controlled signal,
   wherein the output interface is configured to determine the output signal based on the first noise-controlled signal.
Item 12. A hearing aid according to item 11, wherein the first control gain is a predetermined gain.
Item 13. A hearing aid according to item 11, wherein the first control gain is an adaptive gain determined based on the first detector output signal.
Item 14. A hearing aid according to any of items 1-13 comprising:
   a second gain controller configured to receive the second anti-noise signal, determine a second control gain, apply the second control gain to the second anti-noise signal, and output a second noise-controlled signal, and
   wherein the output interface is configured to determine the output signal based on the second noise-controlled signal.
Item 15. A hearing aid according to item 14, wherein the second control gain is a predetermined gain.
Item 16. A hearing aid according to item 14, wherein the second control gain is an adaptive gain determined based on the second detector output signal.
Item 17. A hearing aid according to any of items 1-16 comprising:
   a third detector configured to receive a third detector input signal based on the plurality of input audio signals, determine a third audio parameter based on the third detector input signal, determine a third detector output signal based on the determined third audio parameter, and output a third detector output signal,
   a third noise canceller configured to receive a third noise canceller input signal based on the second beamformed signal and the third detector output signal, determine a third anti-noise signal based on the third noise canceller input signal, wherein the third anti-noise signal is an anti-noise signal for a third type of noise and output a third anti-noise signal, and
   wherein the output interface is configured to determine the output signal based on the third anti-noise signal.
Item 18. A hearing aid according to item 17, wherein the third audio parameter is an audio feedback parameter.
Item 19. A hearing aid according to items 17 or 18 comprising:
   a third gain controller configured to receive the third anti-noise signal, determine a third control gain, apply the third control gain to the third anti-noise signal, and output a third noise-controlled signal,
   wherein the output interface is configured to determine the output signal based on the third noise-controlled signal.
Item 20. A hearing aid according to item 19, wherein the third control gain is an adaptive gain determined based on the first detector output signal.
Item 21. A hearing aid according to item 19, wherein the third control gain is a predetermined gain.
Item 22. A hearing aid according to any of Items 1-21, wherein the first beamformer is a beamformer with a distortion-less criteria.
Item 23. A hearing aid according to any of items 1-22, wherein the second beamformer is a target cancelling beamformer configured to determine the second beamformed signal based on minimizing power of a target based on the plurality of input audio signals.
Item 24. A hearing aid according to any of items 1-23 comprising an air-conduction type hearing aid, a bone-conduction type hearing aid, or a combination thereof.
Item 25. A hearing aid according to any of items 1-24, wherein determining the first anti-noise signal comprises determining a first correlation between the first beamformed signal and the first noise canceller input signal.
Item 26. A hearing aid according to any of items 1-25, wherein determining the first noise canceller comprises normalizing the first correlation using the magnitude of the first noise canceller input signal.
Item 27. A hearing aid according to any of items 1-26, wherein determining the first noise canceller comprises determining a first correlation between the first anti-noise signal and the first noise canceller input signal.
Item 28. A hearing aid according to anyone of items 1-27, wherein determining the first noise canceller comprises reducing the magnitude error between the first beamformed signal and the first noise canceller input signal.
Item 29. A hearing aid according to any of items 1-28, wherein determining the second noise canceller comprises determining a second correlation between the first anti-noise signal and the first noise canceller input signal.
Item 30. A hearing aid according to item 29, wherein determining the first noise canceller comprises normalizing the second correlation using the magnitude of the first noise canceller input signal.
Item 31. A hearing aid according to any of items 1-30, wherein determining the second noise canceller comprises determining a second correlation between the second anti-noise signal and the first noise canceller input signal.
Item 32. A hearing aid according to anyone of items 1-27, wherein determining the first noise canceller comprises reducing the magnitude error between the second anti-noise signal and the first noise canceller input signal.
Item 33. A hearing aid according to any of items 1-32, wherein determining the third noise canceller comprises determining a third correlation between the second anti-noise signal and the first noise canceller input signal.
Item 34. A hearing aid according to claim item 32, wherein determining the third noise canceller comprises normalizing the third correlation using the magnitude of the first noise canceller input signal.
Item 35. A method of operating a hearing aid comprising:
   providing a plurality of input audio signals,
   determining a first beamformed signal based on the plurality of input audio signals,
   determining a second beamformed signal based on the plurality of input audio signals,
   determining a first audio parameter based on the plurality of input audio signal,
   determining a first detector output signal based on the determined first audio parameter,
   determining a first anti-noise signal related to a first type of noise based on the second beamformed signal and the first detector signal,
   determining a second anti-noise signal related to a second type of noise based on the second beamformed signal,
   determining an output signal based on the first beamformed signal, the first anti-noise signal, and the second anti-noise signal,
   outputting the output signal.
Item 36. A method of operating a hearing aid according to item 35, wherein the first beamformed signal and the second beamformed signal are determined by fixed filters, and wherein the first anti-noise signal and the second anti-noise signal are determined by adaptive filters.
Item 37. A method of operating a hearing aid according to Item 35 or 36, wherein the first type of noise is a slow time-varying noise, and wherein the second type of noise is a fast time-varying noise.
Item 38. A method of operating a hearing aid according to any of items 35-37, wherein determining the first detector output signal comprises comparing the first audio parameter to a first threshold,
   if the first audio parameter exceeds the first threshold, determining the first detector output signal as comprising an activation signal allowing the first noise canceller to adapt to the second beamformed signal, and
   if the first detector output signal does not exceed the first threshold, determining the first detector output signal as comprising a fixing signal fixing the first noise canceller.
Item 39. A method of operating a hearing aid according to any of items 35-38 comprising:
   determining a second audio parameter based on the plurality of input audio signal,
   determining a second detector output signal based on the determined second audio parameter, and
   determining the second anti-noise signal based on the second detector signal and the second detector output signal.
Item 40. A method of operating a hearing aid according to any of items 35-39, wherein determining the second detector output signal comprises comparing the second audio parameter to a second threshold,
   if the second audio parameter exceeds the second threshold, determining the second detector output signal as comprising an activation signal allowing the second noise canceller to adapt to the second beamformed signal, and
   if the second detector output signal does not exceed the second threshold, determining the second detector output signal as comprising a fixing signal fixing the second noise canceller.
Item 41. A method of operating a hearing aid according to any of items 39-40, wherein the second audio parameter is a jammer activity parameter.
Item 42. A method of operating a hearing aid according to any of claims 35-41, wherein the first audio parameter is a voice activity parameter.
Item 43. A method of operating a hearing aid according to any of items 35-42 comprising:
   determining a first control gain,
   determining a first noise-controlled signal by applying the first control gain to the first anti-noise signal,
   determining an output signal based on the first noise-controlled signal.
Item 44. A method of operating a hearing aid according to claim 43, wherein the first control gain is determined as a predetermined gain.
Item 45. A method of operating a hearing aid according to item 43, wherein determining the first control gain comprises determining the first control gain as an adaptive gain determined based on the first detector output signal.
Item 46. A method of operating a hearing aid according to any of claims 35-45 comprising:
   determining a second control gain,
   determining a second noise-controlled signal by applying the second control gain to the second anti-noise signal,
   wherein the output interface is configured to determine the output signal based on the second noise-controlled signal.
Item 47. A method of operating a hearing aid according to claim 46, wherein the second control gain is determined as a predetermined gain.
Item 48. A method of operating a hearing aid according to item 46, wherein determining the second control gain comprises determining the second control gain as an adaptive gain determined based on the second detector output signal.
Item 49. A method of operating a hearing aid according to any of items 35-48, comprising
   determining a third audio parameter based on the plurality of input audio signal,
   determining a third detector output signal based on the determined third audio parameter,
   determining a third anti-noise signal related to a third type of noise based on the third beamformed signal and the third detector output signal,
   determining the output signal based on the third anti-noise signal.
Item 50. A method of operating a hearing aid according to item 49, wherein the third audio parameter is an audio feedback parameter.
Item 51. A method of operating a hearing aid according to item 49 or 50:
   determine a third control gain,
   determining a third noise-controlled signal by applying the third control gain to the third anti-noise signal,
   determine the output signal based on the third noise-controlled signal.
Item 52. A method of operating a hearing aid according to item 51, wherein the third control gain is determined as a predetermined gain.
Item 53. A method of operating a hearing aid according to item 51, wherein determining the third control gain comprises determining the third control gain as an adaptive gain determined based on the third detector output signal.
Item 54. A method of operating a hearing aid according to any of the claims 35-53, wherein the first beamformed signal is determined with a distortion-less criteria.
Item 55. A hearing aid according to claim 35-54, wherein the second beamformed signal is determined by minimizing power of a target based on the plurality of input audio signals.
Item 56. A data processing system comprising a processor and program code means for causing the processor to perform the method of any one of items 35-55.
Item 57. A computer program comprising instructions which, when the program is executed by a computer, cause the computer to carry out the method of any one of items 35-55.

1. A hearing aid comprising:
an input interface configured to provide a plurality of input audio signals,
a first beamformer configured to receive a first beamformer input signal based on the plurality of input audio signals, and determine a first beamformed signal based on the first beamformer input signal,
a second beamformer configured to receive a second beamformer input signal based on the plurality of input audio signals, and determine a second beamformed signal based on the second beamformer input signal,
a first detector configured to receive a first detector input signal based on the plurality of input audio signals, determine a first audio parameter based on the first detector input signal, determine a first detector output signal based on the determined first audio parameter, and output the first detector output signal,
a first noise canceller configured to receive a first noise canceller input signal based on the second beamformed signal and the first detector output signal, determine a first anti-noise signal based on the first noise canceller input signal, wherein the first anti-noise signal is an anti-noise signal for a first type of noise, and output the first anti-noise signal,
a second noise canceller configured to receive a second noise canceller input signal based on the second beamformed signal, determine a second anti-noise signal based on the second beamformed signal, wherein the second anti-noise signal is an anti-noise signal for a second type of noise, and output a second anti-noise signal,
an output interface configured to determine an output signal based on the first beamformed signal, the first anti-noise signal, and the second anti-noise signal, and output the output signal.

2. A hearing aid according to claim 1, wherein the first type of noise is a slow time-varying noise, and wherein the second type of noise is a fast time-varying noise.

3. A hearing aid according to claim 1, wherein determining the first detector output signal comprises comparing the first audio parameter to a first threshold,
if the first audio parameter exceeds the first threshold, determining the first detector output signal as comprising an activation signal allowing the first noise canceller to adapt by reducing an error between the first anti-noise signal and a first target signal based on the first beamformed signal, and
if the first audio parameter does not exceed the first threshold, determining the first detector output signal as comprising a fixing signal fixing the first noise canceller.

4. A hearing aid according to claim 1, wherein the first audio parameter is a voice activity parameter.

5. A hearing aid according to claim 1 comprising a second detector configured to receive a second detector input signal based on the plurality of input audio signals, determine a second audio parameter based on the second detector input signal, determine a second detector output signal based on the determined second audio parameter, and output the second detector output signal,
wherein the second noise canceller is configured to receive the second detector output signal, and determine the second anti-noise signal based on the second detector output signal.

6. A hearing aid according to claim 5, wherein the second audio parameter is an interference activity parameter.

7. A hearing aid according to claim 1 comprising:
a first gain controller configured to receive the first anti-noise signal, determine a first control gain, apply the first control gain to the first anti-noise signal, and output a first noise-controlled signal,
wherein the output interface is configured to determine the output signal based on the first noise-controlled signal.

8. A hearing aid according to claim 7, wherein the first gain controller is configured to receive the first detector output signal, and determine the first control gain based on the first detector output signal.

9. A hearing aid according to claim 1 comprising:
a second gain controller configured to receive the second anti-noise signal, determine a second control gain, apply the second control gain to the second anti-noise signal, and output a second noise-controlled signal, and
wherein the output interface is configured to determine the output signal based on the second noise-controlled signal.

10. A hearing aid according to claim 1 comprising:
a third detector configured to receive a third detector input signal based on the plurality of input audio signals, determine a third audio parameter based on the third detector input signal, determine a third detector output signal based on the determined third audio parameter, and output a third detector output signal,
a third noise canceller configured to receive a third noise canceller input signal based on the second beamformed signal and the third detector output signal, determine a third anti-noise signal based on the third noise canceller input signal, wherein the third anti-noise signal is an anti-noise signal for a third type of noise and output a third anti-noise signal, and
wherein the output interface is configured to determine the output signal based on the third anti-noise signal.

11. A hearing aid according to claim 9, wherein the third audio parameter is an audio feedback parameter.

12. A hearing aid according to claim 1, wherein the first noise canceller comprises a first smoothing factor, wherein the second noise canceller comprises a second smoothing factor,
wherein the smoothing factors defines the adaptation rate of the associated noise canceller,
wherein the first smoothing factor results in a lower adaptation rate than the second smoothing factor.

13. A method of operating a hearing aid comprising:
providing a plurality of input audio signals,
determining a first beamformed signal based on the plurality of input audio signals,
determining a second beamformed signal based on the plurality of input audio signals,
determining a first audio parameter based on the plurality of input audio signal,
determining a first detector output signal based on the determined first audio parameter,
determining a first anti-noise signal related to a first type of noise based on the second beamformed signal and the first detector signal,
determining a second anti-noise signal related to a second type of noise based on the second beamformed signal,
determining an output signal based on the first beamformed signal, the first anti-noise signal, and the second anti-noise signal,
outputting the output signal.
